(19) United States
(12) Patent Application Publication
(10) Pub. No.: US 2015/0267063 A1
(43) Pub. Date: Sep. 24, 2015

(54) Coating Composition and Use Thereof

(71) Applicant: BYK-CHEMIE GMBH, Wesel (DE)

(72) Inventors: Anne Drewer, Oberhausen (DE); Ninja Hanitzsch, Oberhausen (DE); Michael Berkei, Haltern am See (DE); Ulrich Nolte, Kleve (DE); Tobias Tinthoff, Bochold (DE); Ralf Koch, Wesel (DE)

(73) Assignee: BYK-Chemie GmbH, Wesel (DE)

(21) Appl. No.: 14/435,248

(22) PCT Filed: Sep. 20, 2013
(86) PCT No.: PCT/EP2013/069600

§ 371 Date: Apr. 13, 2015

(30) Foreign Application Priority Data
Oct. 11, 2012 (EP) 12007073.5
Nov. 8, 2012 (EP) 12007613.8

(51) Int. Cl. C09D 5/24; A01C 1/06

(52) U.S. Cl. CPC C09D 5/24; A01C 1/06

(57) ABSTRACT

The invention relates to a seed coating composition, especially for providing seed (1), preferably seed in the form of seed grains (2) or the like, with at least one antistatic or electrically conductive or electro-static dissipative coating (3), and to the use thereof.

### CROSS-REFERENCES TO RELATED APPLICATIONS

This application is a National Stage filing of International Application PCT/EP 2013/069600, filed Sep. 20, 2013, claiming priority to EP 12 007 073.5 filed Oct. 11, 2012, and EP 12 007 613.8 filed Nov. 8, 2012, entitled “Coating Composition and Use Thereof.” The subject application claims priority to PCT/EP 2013/069600, and to EP 12 007 073.5, and EP 12 007 613.8 and incorporates all by reference herein, in their entirety.

### BACKGROUND OF THE INVENTION

The present invention pertains to the technical field of the coating of seed, or grains of seed, more particularly for the sector of agriculture and also for the commercial and domestic sector of horticulture.

The present invention relates more particularly to a seed coating composition, more particularly for the furnishing of seed with at least one antistatic and/or electrically conductive and/or electrodissipative coating.

The present invention further relates to the use of an at least substantially metal-free, preferably metal-free, and also electrically conductive additive for producing a seed coating composition and seed coating, and also to the use of an at least substantially metal-free, preferably metal-free, and electrically conductive additive for the antistatic and/or electrically conductive and/or electrodissipative furnishing of seed or for the corresponding furnishing of a seed coating as such which is applied on the seed.

The present invention relates, moreover, to the use of the seed coating composition of the invention for the antistatic and/or electrically conductive and/or electrodissipative furnishing of seed.

The present invention relates, furthermore, to a method for producing the seed coating composition of the invention which has antistatic and/or electrically conductive and/or electrodissipative properties, and also to the seed coating composition as such that is obtainable by the method of the invention.

The present invention further relates to a method for producing seed furnished with a coating, more particularly in the form of seed grains or the like.

Lastly, the present invention also relates to the seed of the invention, more particularly in the form of seed grains or the like, which is furnished with an antistatic and/or electrically conductive and/or electrodissipative coating based on the seed coating composition of the invention.

Seed, present generally in the form of particulate or particle-form seed grains or (plant) seeds, comprises, in particular, generative or germinable propagation organs of plants, which in general contain the complete germ of the plant, which has come about as a result of fertilization, and which usually are in a state of dormancy. The dormancy can be interrupted by specific factors, such as moisture, temperature, light, or the like, leading to the subsequent germination of the seed, with formation of the shoot or of the (young) plant.

Generally speaking, seed which is used, for example, in large quantities in agriculture for the tilling of fields, but also in smaller quantities in the horticultural sector, is a sensitive biological material which especially if processed and stored under less than optimum conditions, can lose quality or germination capacity—if, for example, the seed is processed or stored under conditions which are too hot, too humid, or else too light.

Accordingly, under adverse processing conditions and particularly under adverse storage conditions, the seed may within a short time undergo rotting and/or may become unusable with a loss of germination capacity, the failures in question being possibly brought about, for example, by premature and hence unwanted germination or as a result of infestation by fungi, parasites, or the like. The consequent quality detractions lead to non-optimum utilization or germination of the seed, accompanied by losses in yield, and hence also to a financial loss, not least because industrially available seed constitutes an expensive, high-performance specialty product. High losses of seed grains with capacity for germination are also important, however, in relation to less expensive seed varieties, since such varieties are often stored in very much larger quantities, thus additionally increasing their susceptibility to adverse environmental factors.

Against this background, therefore, there has been a great demand in the prior art to furnish seed with a high resistance and durability or storage stability, in order thereby to obtain optimum germination and growth characteristics.

Known within the prior art in this context is the furnishing of seed with a coating or covering, this also being referred to in general as seed coating.

The coating or enveloping compositions employed for this purpose are furnished with various substances intended to enhance seed quality, such as bactericides or fungicides, for example, which are intended in particular to improve the storage stability of seed, by virtue of reduced bacterial, fungal or mold infestation.

The coating systems known from the prior art may equally be provided, for example, with substances beneficial for germination and/or for growth, such as, for example, fertilizers and vitamins on the one hand, in order thus to optimize the growth conditions in terms of nutrient supply, and herbicides on the other, in order thus to prevent the growth of competing weeds or the like, especially during the seed germination phase.

Furthermore, coating systems of this kind for seed are also used against the background of increasing or harmonizing the mass of the seed, in order thereby in particular to achieve improvements in dispensing, metering, and broadcasting operations and/or in the sowing of the seed. Often used as well are dyes or color pigments, especially in order to enable visual identification of the seed.

WO 2012/118795 A2, or US 2012/220454 A1, relates to a polymer-based seed composition intended as a basis for increasing the water absorption of the coating.

Furthermore, WO 2007/033931 A1, or US 2009/270259 A1, relates to a method for producing a formulation with controlled active ingredient delivery, which can be used as a seed coating, it being possible for the composition also to comprise growth promoting or biocidal ingredients.

EP 2 229 808 A1, or US 2012/065060 A1, moreover, concerns a coating system for plant seeds that comprises not only inorganic particles but also further ingredients, such as growth promoter substances and biocidal substances. Also described is the use of color pigments and/or effect pigments.

A disadvantage affecting known coating systems in general is often their less than optimum composition, and not least in respect of environment-specific and/or food-specific aspects, this being the case not least against the background of the occasional use in the prior art of metal-containing, or heavy-metal-containing, compounds, in the form of color pigments or the like, for example.

Furthermore, the coating systems known in the prior art do not do justice to the electrostatic effects, and to the problems associated with them, that occur both in the processing and handling of seed, especially industrially, and also in the metering and sowing of this seed.

The reason is that the seed grains that form the seed may become electrostatically charged, especially in the course of industrial processing, as for example during coating operations or else during packing or portioning, and also in the course of handling with the end user, in the case of removal from surrounding packaging and/or during sowing, for example, and this electrostatic charging may give rise to problems, in some cases serious problems, affecting more particularly the processing or portioning, removal from packaging, or else broadcasting and/or sowing of the seed.

The reason for the electrostatic charging lies in particular in the dielectric properties of the seed and also in the movement and friction of the seed that occur in the course of processing and/or handling; this leads to a corresponding charge separation, with accompanying electrostatic charging of the seed.

Examples of possible consequences of the electrostatic charging of the seed include forces of attraction in relation to processing, portioning, and singularizing equipment, surrounding packaging, or the like, with the possible consequence to a certain extent of unwanted “sticking” or adhering of the individual seed grains to corresponding constituents and/or walls of processing machinery or packaging. Because of the electrostatic charging, moreover, there may also, for example, be forces of repulsion, in particular of the seed grains with one another, this being equally undesirable, in relation for example to portioning or singularization and to the broadcasting of the seed.

The effects accompanying electrostatic charging occur to a particular extent with seed grains of low weight or small size, but are equally also an issue for heavier and/or larger grains of seed.

The electrostatic effects which occur are also a disadvantage, in particular, in the context of industrial processing and/or handling, with regard for example to the application of coatings to such seed grains. Because of the electrostatic forces which occur, it is often not possible, in particular, to achieve uniform coating of the seed grains.

Furthermore, the electrostatic charging significantly impairs the free-flowability of the seed, this being a problem in terms of portioning or singularizing of the seed, a problem which is all the more serious in view of the fact that especially in the highly industrialized agricultural economy, efficient use of the seed is very important not least on economic grounds.

Even in the case of application in the noncommercial sector, such as in domestic horticulture, for example, the effects associated with the electrostatic charging of the seed are a disadvantage, however, with regard, for example, to the handling of the seed on removal from (surrounding) packaging or the like, since the individual seed grains often remain adhering to the packaging, and this is undesirable.

Against this background, there have already been initial approaches in the prior art to implementing corresponding measures whose intention is to counteract the electrostatic effects under discussion.

Hence there has been provision in the prior art, for example, to provide the seed, against this background, with a coating in order to increase the mass of the seed. This, however, does not fundamentally counter electrostatic charging, but instead leads only to a certain reduction in the effects caused by the electrostatic charging, on account of the higher mass.

A disadvantage with this approach, moreover, is that sometimes excessively large quantities of material must be applied, with impairment overall to the handling of the seed and with higher packaging costs and transport costs as a result, for example, of the higher volume and weight.

Another approach in the prior art is to furnish the coating system with antistatic properties through the use of inorganic, heavy-metal-containing compounds. In this respect, the prior art has provided in particular the use of antimony-doped tin oxides. Disadvantages in this case, however, are on the one hand the poor handling qualities, since the inorganic compound in question is applied as a separate coat, and, on the other hand, the poor environmental compatibility and poor feed compatibility that result from the use of compounds containing heavy metal.

Another approach in the prior art lies in the use of specific salt compounds based on tetraalkylammonium salts. Because of their polar structure, these salts have hygroscopic properties, in some cases strongly so, resulting in a certain conductivity as a result of the associated incorporation of water in the coat. A particular disadvantage in this respect, however, is that excessive water contents in the underlying coat may have the effect, for example, of inducting premature germination of the seed and/or may lead to fungal or mold infestation.

### BRIEF SUMMARY OF THE INVENTION

It is an object of the present invention, therefore, to provide a seed coating composition, and seed coated therewith, where the intention is that the disadvantages and problems outlined above and associated with the prior art should at least be largely prevented or else at least attenuated.

An object of the present invention, more particularly, is that of providing an efficient antistatic or electrically conductive coating composition for seed, and seed as such that is furnished with a coating composition of this kind, said composition and seed having antistatic properties, resulting in advantages not only from the production and processing standpoint but also in specific relation to application, more particularly in relation to improved handling qualities during the production of the coating as such, and also the singularization or metering and the broadcasting or sowing of the seed.

Another object of the present invention, furthermore, is that of providing a seed coating composition and seed coated therewith that exhibit not only high food safety and food compatibility but also high environmental compatibility.

Another object of the present invention, moreover, is that of providing an effective method for the coating of seed leading to efficient antistatic furnishing of seed treated in this way, the intention being that the underlying method should both be easy-to-use and cost-effective.

The objective outlined above is achieved in accordance with the invention by a seed coating composition as described in Point 1 of the Points of Novelty found at the end of this section; further, advantageous developments and refinements of the seed coating composition of the invention are subjects of the other relevant dependent Points of Novelty.

A further subject of the present invention, moreover, is the inventive use of an at least substantially metal-free, preferably metal-free, electrically conductive additive for producing a corresponding seed coating composition and a corresponding seed coating, in accordance with the relevant use Point of Novelty.

A subject of the present invention, furthermore, is the use of the seed coating composition of the invention for the antistatic and/or electrically conductive and/or electrodissipative furnishing of seed, in accordance with the relevant use Point of Novelty.

In turn a further subject of the present invention is the method of the invention for producing the seed coating composition of the invention, in accordance with the relevant method Point of Novelty.

In this context, a further subject of the present invention is the seed coating composition obtainable in this way, in accordance with the relevant Point of Novelty pertaining to the composition.

A subject of the present invention, moreover, is the method for producing coated seed, in accordance with the relevant method Point of Novelty. Further, advantageous developments and refinements of the method of the invention according to this aspect are subjects of the corresponding dependent Point of Novelty.

A final subject of the present invention is seed furnished with at least one coating based on the seed coating composition of the invention, in accordance with the relevant Point of Novelty pertaining to the seed as such. Further, advantageous developments and refinements of the seed of the invention are subjects of the relevant dependent Points of Novelty.

It is self-evident that refinements, embodiments, advantages, and the like which are stated below only for one aspect of the invention, so as to avoid unnecessary repetition, do also of course apply correspondingly in relation to the other aspects of the invention.

It is self-evident, furthermore, that where figures are given below for values, numbers and ranges, the respective value, number, and range data should not be interpreted restrictively; for a person skilled in the art, it is self-evident that there may be deviation from the stated ranges or figures or data on an individual case basis or for application reasons, without departing from the scope of the present invention.

It is the case, furthermore, that all value data and parameter data or the like given below can be determined or ascertained fundamentally using normalized or standardized or explicitly stated determination methods, or else with determination methods that are familiar per se to the skilled person in this field.

Furthermore, in the case of stated percentages for amounts of ingredients or the like that are used, the quantitative proportions should be combined in such a way as to result in total in 100% or 100 wt %. This as well is self-evident to the skilled person.

With these provisos, the invention will be described in more detail below.

### Points of Novelty

1. A seed coating composition, more particularly for the furnishing of seed, preferably seed in the form of seed grains or the like, with at least one antistatic and/or electrically conductive and/or electrodissipative coating,

where the coating composition has at least one at least substantially metal-free, preferably metal-free, electrically conductive additive.
2. The coating composition as described in point 1,

where the conductive additive is salt-free, more particularly ammonium salt-free, and/or non-hygroscopic and/or free from amino groups and/or free from ether groups in form and/or

where the conductive additive is an electrically conductive carbon allotrope and/or an electrically conductive polymer.
3. The coating composition as described in points 1 or 2,

where the conductive additive, more particularly the conductive carbon allotrope and/or the conductive polymer, has conjugated aromatic systems and/or conjugated double bonds and/or conjugated n electron systems and/or

where the conductive additive, more particularly the conductive carbon allotrope and/or the conductive polymer, is capable of forming preferably electrically conductive aggregates and/or electrically conductive networks and/or

where the conductive additive, more particularly the conductive carbon allotrope and/or the conductive polymer, has an electrical conductivity and/or conductance in the range from 10⁻¹³ to 10⁵ S/cm, more particularly 10⁻¹² to 10⁴ S/cm, preferably 10⁻¹⁰ to 10³ S/cm and/or

where the conductive additive, more particularly the conductive carbon allotrope and/or the conductive polymer, preferably the conductive carbon allotrope, is particle-shaped and/or particulate in form, more particularly where the conductive additive is granular, spherical, expanded, lamellar, flakelike, cylindrical, conical or frustoconical in form and/or

where the conductive additive, more particularly the conductive carbon allotrope and/or the conductive polymer, preferably the conductive carbon allotrope, has an average particle size, more particularly an average particle size D50, in the range from 0.05 nm to 1000 μm, more particularly 0.1 nm to 800 μm, preferably 1 nm to 600 μm, more preferably 10 nm to 500 μm.
4. The coating composition as described in points 2 or 3,

where the conductive carbon allotrope is particle-shaped and/or particulate in form and/or

where the conductive carbon allotrope, more particularly based on the individual particles, is granular, spherical, expanded, lamellar, flakelike, cylindrical, conical or frustoconical in form and/or

where the conductive carbon allotrope has an average particle size, more particularly an average particle size D50, in the range from 0.05 nm to 1000 μm, more particularly 0.1 nm to 800 μm, preferably 1 nm to 600 μm, more preferably 10 nm to 500 μm and/or

where the conductive carbon allotrope, based on the individual particles of the carbon allotrope, has an aspect ratio, calculated as ratio of the width to the height of the particles, in the range from 1 to 10 000, more particularly greater than 1, preferably greater than 10, more preferably greater than 100.
5. The coating composition as described in any of points 2 to 4,

where the carbon allotrope is selected from the group of
(i) optionally modified graphites, more particularly at least partly oxidized and/or fully or partly intercalated graphites and expandable graphites;
(ii) optionally modified graphenes, more particularly single-layer or multilayer graphenes (Few Layer Graphenes), graphene strips, and doped graphenes;
(iii) fullerenes, more particularly C₆₀ fullerene, C₇₀ fullerene, C₇₆ fullerene, C₈₀ fullerene, C₈₂ fullerene, C₈₄ fullerene, C₈₆ fullerene, C₉₀ fullerene, and C₉₄ fullerene, preferably C₆₀ fullerene and C₇₀ fullerene;
(iv) optionally modified carbon nanotubes (CNTs), more particularly doped and/or functionalized carbon nanotubes, single-wall carbon nanotubes (SWCNTs), multiwall carbon nanotubes (MWCNTs), carbon nanotubes with bamboo structure, and cup-stacked carbon nanotubes (CSCNTs);
(v) carbon blacks, more particularly Conductive Carbon Black;
(vi) carbon fibers;
(vii) optionally modified Carbon Nanohorns (CNHs), more particularly single-wall, double-wall, and multiwall Carbon Nanohorns;
(viii) Carbon Nanocones (CNCs);
(ix) Onion-Like Carbons (OLCs); and

their combinations or mixtures and/or

where graphites, graphenes, fullerenes, carbon nanotubes (CNTs) and/or carbon blacks are used as conductive carbon allotrope and/or

where carbon nanotubes (CNTs) and/or carbon blacks are used as conductive carbon allotrope.
6. The coating composition as described in point 5,

where (i) the optionally modified graphites have an average particle size, more particularly an average particle size D50, based on the width of the individual graphite particles, in the range from 0.01 μm to 100 μm, more particularly 0.1 μm to 50 μm, preferably 1 μm to 30 μm and/or

where (i) the optionally modified graphites have an average particle size, more particularly an average particle size D50, based on the height of the individual graphite particles, in the range from 0.5 nm to 1000 nm, more particularly 1 nm to 500 nm, preferably 5 nm to 100 nm and/or

where (i) the optionally modified graphites have a specific surface area (BET surface area) in the range from 10 m²/g to 2000 m²/g, more particularly 15 m²/g to 1800 m²/g, preferably 20 m²/g to 1700 m²/g, more preferably 50 m²/g to 1600 m²/g.
7. The coating composition as described in point 5, where (ii) the optionally modified graphenes are used in the form of multilayer graphenes and/or where the graphenes have up to 100 layers, more particularly 1 to 100 layers, preferably 1 to 50 layers, more preferably to 30 layers, very preferably 1 to 20 layers, especially preferably 1 to 10 layers.
8. The coating composition as described in point 5, where (iii) the fullerenes have a particle diameter in the range from 7 Å to 15 Å.
9. The coating composition as described in point 5,

where (iv) the carbon nanotubes (CNTs) used are used in the form of single-wall carbon nanotubes (SWCNTs) and/or multiwall carbon nanotubes (MWNTs), more particularly where the multiwall carbon nanotubes (MWNTs) are selected from 2- to 30-wall, preferably 3- to 15-wall, carbon nanotubes, and/or

where (iv) the carbon nanotubes (CNTs) used have average internal diameters in the range from 0.4 to 50 nm, more particularly in the range from 1 to 10 nm, preferably in the range from 2 to 6 nm, and/or

where (iv) the carbon nanotubes (CNTs) used have average external diameters in the range from 1 to 60 nm, more particularly in the range from 5 to 30 nm, preferably in the range from 10 to 20 nm, and/or

where (iv) the carbon nanotubes (CNTs) used have average lengths in the range from 0.01 to 1000 μm, more particularly in the range from 0.1 to 500 μm, preferably in the range from 0.5 to 200 μm, more preferably in the range from 1 to 100 μm, and/or

where (iv) the carbon nanotubes (CNTs) used have a specific electrical conductivity of at least 10³ S/cm, more particularly at least 0.5.10⁴ S/cm, preferably at least 10⁴ S/cm.
10. The coating composition as described in point 5,

where (v) the carbon blacks, more particularly the primary particles of carbon black, have an average particle size, more particularly an average particle size D50, in the range from 1 nm to 1000 nm, more particularly 10 nm to 800 nm, preferably 50 nm to 500 nm and/or

where (v) the carbon blacks have a specific surface area (BET surface area) in the range from 10 m²/g to 2000 m²/g, more particularly 15 m²/g to 1800 m²/g, preferably 20 m²/g to 1700 m²/g, more preferably 50 m²/g to 1600 m²/g and/or

where (v) the carbon blacks have an oil absorption in the range from 10 to 500 ml/100 g, more particularly 15 to 450 ml/100 g, preferably 20 to 400 ml/100 g.
11. The coating composition as described in point 5,

where (vi) the carbon fibers have an average fiber diameter, more particularly an average fiber diameter D50, in the range from 1 μm to 20 μm, more particularly 2 μm to 15 μm, preferably 3 μm to 10 μm and/or

where (vi) the carbon fibers have an average fiber length, more particularly an average fiber length D50, in the range from 20 μm to 500 μm, more particularly 30 μm to 400 μm, preferably 50 μm to 300 μm and/or

where (vi) the carbon fibers have a specific electrical resistance ρ in the range from 10⁻² Ω·m to 10⁻⁷ Ω·m, more particularly 10⁻⁴ Ω·m to 10⁻⁶ Ω·m.
12. The coating composition as described in point 5,

where (vii) the Carbon Nanohorns (CNHs) have average lengths in the range from 10 to 100 nm, more particularly in the range from 20 to 80 nm, preferably in the range from 40 to 50 nm and/or

where (vii) the Carbon Nanohorns (CNHs) have average diameters in the range from 0.5 to 10 nm, more particularly in the range from 1 to 8 nm, preferably in the range from 1.5 to 5 nm, more preferably in the range from 2 to 3 nm and/or

where (vii) the Carbon Nanohorns (CNHs) have a specific surface area (BET surface area) in the range from 10 m²/g to 1500 m²/g, more particularly 15 m²/g to 1000 m²/g, preferably 20 m²/g to 800 m²/g, more preferably 50 m²/g to 500 m2/g.

35
13. The coating composition as described in point 5, where (viii) the Carbon Nanocones (CNCs) have an at least substantially conic form and/or are conical, more particularly where the ratio of the base area diameter to the height of the Carbon Nanocones (CNCs) is in the region of 1.
14. The coating composition as described in point 5, where (ix) the Onion-Like Carbons (OLCs) are at least substantially spherical and/or where (ix) the Onion-Like Carbons (OLCs) have average particle sizes, more particularly average particle sizes D50, in the range from 5 nm to 50 nm, more particularly 5 nm to 30 nm, preferably 10 nm to 20 nm.
15. The coating composition as described in points 2 or 3, where the conductive polymer is selected from the group of polyacetylenes, polyanilines, polyparaphenylenes, polystyrenes, polythiophenes, polyethylenedioxythiophenes (PEDOT), polyethylene-dioxythiophenes:polystyrenesulfonates (PEDOT:PSS), and polyphenylenevinylenes, more particularly polyacetylenes, polyanilines, polyparaphenylenes, polystyrenes, and polythiophenes.
16. The coating composition as described in any of the preceding points, where the coating composition has the conductive additive, more particularly the electrically conductive carbon allotrope and/or the electrically conductive polymer, in amounts in the range from 0.0001 wt % to 70 wt %, more particularly 0.001 wt % to 60 wt %, preferably 0.01 wt % to 50 wt %, more preferably 0.1 wt % to 40 wt %, very preferably 0.2 wt % to 20 wt %, especially preferably 0.5 wt % to 15 wt %, more preferably still 1 wt % to 10 wt %, based on the composition.

17. The coating composition as described in any of the preceding points,

where the coating composition is present as a dispersion, preferably as an aqueous and/or aqueously based dispersion, and/or as a solubilizate, more particularly aqueous and/or aqueously based solubilizate, more particularly where the conductive additive, more particularly the electrically conductive carbon allotrope and/or the electrically conductive polymer, is incorporated in a continuous phase and/or in at least one carrier medium, more particularly dispersion medium and/or solubilization medium, and/or

where the coating composition is in the form of a dispersion, preferably an aqueous and/or aqueously based dispersion.

18. The coating composition as described in point 17,

where use is made as continuous phase and/or carrier medium, more particularly as dispersion medium and/or solubilization medium, of an aqueously, organically or aqueous-organically based carrier medium, more particularly dispersion medium and/or solubilization medium, preferably an aqueously or aqueously organic carrier medium, more preferably aqueously based carrier medium, and/or

where use is made as continuous phase and/or carrier medium of a carrier medium which is present in the liquid aggregate state under dispersing and/or solubilizing conditions, more particularly under atmospheric pressure (101.325 kPa) and in a temperature range from 10 to 100° C., preferably 15 to 70° C.
19. The coating composition as described in points 17 or 18,

where the carrier medium, more particularly the dispersion medium and/or the solubilization medium, is selected from the group of (i) water; (ii) alcohols, more particularly straight-chain, branched or cyclic, monohydric or polyhydric alcohols; (iii) ether alcohols; (iv) hydrocarbons; (v) ethers; (vi) carboxylic esters; (vii) ether esters; (viii) lactones; (ix) plasticizers, more particularly phthalates; (x) aldehydes and ketones; (xi) acid amides, (xii) N-methylpyrrolidone; and also combinations of the aforesaid carrier media and/or

where the carrier medium, more particularly the dispersion medium and/or the solubilization medium, comprises water and/or where the dispersion medium is water.
20. The coating composition as described in any of points 17 to 19, where the coating composition comprises the carrier medium, more particularly the dispersion medium and/or the solubilization medium, in amounts in the range from 0.1 wt % to 99 wt %, more particularly 1 wt % to 95 wt %, preferably 5 wt % to 90 wt %, more preferably 10 wt % to 80 wt %, very preferably 20 wt % to 60 wt %, based on the composition, and/or

where the coating composition comprises the carrier medium, more particularly the dispersion medium and/or the solubilization medium, in amounts in the range from 10 wt % to 1000 wt %, more particularly 25 wt % to 500 wt %, preferably 50 wt % to 400 wt %, more preferably 75 wt % to 350 wt %, very preferably 100 wt % to 300 wt %, especially preferably 150 wt % to 250 wt %, based on the conductive additive, more particularly the electrically conductive carbon allotrope and/or the electrically conductive polymer.

21. The coating composition as described in any of the preceding points, where the coating composition comprises at least one dispersant and/or wetting agent, more particularly a polymeric dispersant and/or wetting agent, preferably based on a functionalized polymer, preferably having a number-average molecular mass of at least 500 g/mol, preferably at least 1000 g/mol, more preferably at least 2000 g/mol, more particularly where the dispersant is selected from the group of polymers and copolymers having functional and/or pigment-affinity groups, alkylammonium salts of polymers and copolymers, polymers and copolymers having acidic groups, comb copolymers and block copolymers, such as block copolymers having, in particular, basic pigment-affinity groups, optionally modified acrylate block copolymers, optionally modified polyurethanes, optionally modified and/or salinated polyamines, phosphoric esters, ethoxylates, polymers and copolymers with fatty acid radicals, optionally modified polyacrylates, such as transesterified polyacrylates, optionally modified polyesters, such as acid-functional polyesters, polyphosphates, and combinations thereof.
22. The coating composition as described in point 21, where the coating composition comprises the dispersant and/or wetting agent in amounts in the range from 0.1 wt % to 50 wt %, more particularly 0.5 wt % to 40 wt %, preferably 1 wt % to 30 wt %, more preferably 2 wt % to 10 wt %, based on the composition.
23. The coating composition as described in any of the preceding points, where the coating composition has at least one matrix and/or scaffold substance, more particularly where the matrix and/or scaffold substance is selected from the group of natural, nature-identical, and synthetic polymers, preferably water-soluble and/or water-dispersible polymers, and/or more particularly where the matrix and/or scaffold substance is selected from the group of methylcellulose, carboxymethylcellulose, hydroxypropylcellulose, alginate, gelatin, casein, polyurethanes, polyacrylates, polyacrylamides, polyvinyl alcohols, polyvinyl acetates, polyvinylpyrrolidones, and waxes, more particularly beeswax, carnauba wax, polyethylene wax, and polypropylene wax, and combinations thereof.

24. The coating composition as described in point 23, where the coating composition comprises the matrix and/or scaffold substance in amounts in the range from 0.5 wt % to 70 wt %, more particularly 1 wt % to 60 wt %, preferably 2 wt % to 50 wt %, more preferably 5 wt % to 20 wt %, based on the composition.
25. The coating composition as described in any of the preceding points, where the coating composition has at least one thickener and/or one viscosity-increasing agent, more particularly where the thickener and/or the viscosity-increasing agent is selected from the group of pectins, alginates, tragacanth, gum arabic, guar gum, carrageenan, carboxymethylcellulose, carboxypropylcellulose, polyacrylates, polysaccharides, urea derivatives, and clays, more particularly bentonite clays, and combinations thereof.
26. The coating composition as described in point 25, where the coating composition comprises the thickener and/or the viscosity-increasing agent in amounts in the range from 0.001 wt % to 25 wt %, more particularly 0.01 wt % to 10 wt %, preferably 0.05 wt % to 5 wt %, more particularly 0.1 wt % to 4 wt %, very preferably 0.5 wt % to 2 wt %, based on the composition.
27. The coating composition as described in any of the preceding points, where the coating composition has at least one defoamer, more particularly where the defoamer is selected from the group of polyethers, polyacrylates, glycerol, polyethylene glycol, and polysiloxanes, and combinations thereof.
28. The coating composition as described in point 27, where the coating composition comprises the defoamer in amounts in the range from 0.001 wt % to 3 wt %, more particularly 0.01 wt % to 2 wt %, preferably 0.1 wt % to 1 wt %, more preferably 0.2 wt % to 1 wt %, based on the composition.
29. The coating composition as described in any of the preceding points, where the coating composition comprises at least one granulating assistant, more particularly where the granulating assistant is a wax, more particularly beeswax, carnauba wax, polyethylene wax and/or polypropylene wax.
30. The coating composition as described in any of the preceding points, where the coating composition comprises at least one pelletizing agent, more particularly where the pelletizing agent is peat, clay and/or starch.
31. The coating composition as described in any of the preceding points, where the coating composition comprises at least one further additive and/or at least one further ingredient, more particularly where the further additive and/or the further ingredient are/is selected from the group of fillers, more particularly carbonates, preferably calcium carbonate; granulating agents; adhesion promoters; rheology modifiers; pH modifiers; antiblocking and/or antistick agents, more particularly waxes; plasticizers; UV adsorbers; flow control agents; dyes and color pigments; and combinations thereof.
32. The coating composition as described in point 31, where the coating composition comprises the further additive and/or the further ingredient in amounts in the range from 0.0001 wt % to 40 wt %, more particularly 0.001 wt % to 30 wt %, preferably 0.01 wt % to 20 wt %, more preferably 0.1 wt % to 15 wt %, based on the composition.
33. The coating composition as described in any of the preceding points, where the coating composition comprises at least one biologically active ingredient, more particularly where the biologically active ingredient is selected from the group of biocides, more particularly fungicides, herbicides, bactericides, insecticides, microbicides, molluscicides, and virucides; fertilizers; nutrients; vitamins; germination and/or growth regulators, more particularly hormones, preferably phytohormones; and combinations thereof.
34. The coating composition as described in point 33, where the coating composition comprises the biologically active ingredient in amounts in the range from 0.0001 wt % to 20 wt %, more particularly 0.001 wt % to 15 wt %, preferably 0.01 wt % to 10 wt %, more preferably 0.1 wt % to 5 wt %, based on the composition.
35. The coating composition as described in any of the preceding points, where the coating composition is at least substantially metal-free, more particularly metal-free, preferably heavy metal-free, or at least low-metal-content, more particularly low-heavy-metal-content, in form, more particularly where the coating composition has a metal content, more particularly a heavy metal content, of at most 0.1 wt %, more particularly at most 0.01 wt %, preferably at most 0.001 wt %, more preferably at most 0.0001 wt %, very preferably at most 0.00001 wt %, especially preferably at most 0.000001 wt %, based on the composition.
36. The coating composition as described in any of the preceding points, where the coating composition is at least substantially free from metal-containing pigments and/or metal-containing dyes.
37. The coating composition as described in any of the preceding points, where the coating composition has a fluid and/or liquid consistency in particular under processing and/or use conditions, more particularly under atmospheric pressure (101.325 kPa) and in a temperature range from 10 to 100° C., preferably 15 to 70° C.
38. The coating composition as described in any of the preceding points,

where the coating composition, in particular under processing and/or use conditions, more particularly under atmospheric pressure (101.325 kPa) and in a temperature range from 10 to 100° C., preferably 15 to 70° C., has a dynamic viscosity in the range from 10 to 50 000 mPa·s, more particularly 25 to 30 000 mPa·s, preferably 50 to 25 000 mPa·s, more preferably 75 to 20 000 mPa·s and/or

where the coating composition in the dried and/or cured state has a total residual moisture content of 0.001 to 5 wt %, more particularly 0.01 to 3 wt %, preferably 0.1 to 2 wt %, more preferably 0.5 to 1 wt %, based on the coating composition and/or

where the coating composition in the dried and/or cured state has a total residual moisture content of at most 5 wt %, more particularly at most 3 wt %, preferably at most 2 wt %, more preferably at most 1 wt %, based on the coating composition.
39. The coating composition as described in any of the preceding points,

where the coating composition in the dried and/or cured state has a specific surface resistance σₛ of at most 10¹² Ω/sq, more particularly at most 10¹¹ Ω/sq, preferably at most 10¹⁰ Ω/sq, more preferably at most 10⁹ Ω/sq, very preferably at most 10⁸ Ω/sq and/or

where the coating composition in the dried and/or cured state has a specific surface resistance σₛ in the range from 10⁻³ Ω/sq to 10¹² Ω/sq, more particularly in the range from 10⁻¹ Ω/sq to 10¹¹ Ω/sq, preferably in the range from 10⁰ Ω/sq to 10¹⁰ Ω/sq, more preferably in the range from 10¹ Ω/sq to 10⁹ Ω/sq, very preferably in the range from 10² Ω/sq to 10⁸ Ω/sq.
40. The coating composition as described in any of the preceding points,

where the coating composition in the dried and/or cured state has a specific resistance ρₛ and/or a resistivity of at most 10¹⁰ Ω·m, more particularly at most 10⁵ Ω·m, preferably at most 10³ Ω·m and/or

where the coating composition in the dried and/or cured state has a specific resistance ρₛ and/or a resistivity in the range from 10⁻⁷ Ω·m to 10¹⁰ Ω·m, more particularly in the range from 10⁻⁶ Ω·m to 10⁵ Ω·m, preferably in the range from 10⁻⁵ Ω·m to 10³ Ω·m.
41. The use of at least one at least substantially metal-free, preferably metal-free, electrically conductive additive, more particularly of an electrically conductive carbon allotrope and/or of an electrically conductive polymer, preferably as defined in any of points 1 to 16, for producing an antistatic and/or electrically conductive and/or electrodissipative seed coating composition and/or seed coating.
42. The use of at least one at least substantially metal-free, preferably metal-free, electrically conductive additive, more particularly of an electrically conductive carbon allotrope and/or of an electrically conductive polymer, preferably as defined in any of points 1 to 16, for the antistatic and/or electrically conductive and/or electrodissipative furnishing of seed, more particularly seed coating.
43. The use of a coating composition for the antistatic and/or electrically conductive and/or electrodissipative furnishing of seed, where the coating composition has at least one at least substantially metal-free, preferably metal-free, electrically conductive additive, more particularly an electrically conductive carbon allotrope and/or an electrically conductive polymer, preferably as defined in any of points 1 to 16.
44. A method for producing an antistatic and/or electrically conductive and/or electrodissipative seed coating composition, more particularly for the furnishing of seed, where at least one at least substantially metal-free, preferably metal-free, electrically conductive additive, more particularly an electrically conductive carbon allotrope and/or an electrically conductive polymer, preferably as defined in any of points 1 to 16, is dispersed in a continuous phase and/or in a carrier medium, more particularly dispersion medium and/or solubilization medium, preferably in the presence of at least one dispersant and/or wetting agent, with introduction of an energy input sufficient for dispersing.
45. A seed coating composition, more particularly for the antistatic and/or electrically conductive and/or electrodissipative furnishing of seed, where the seed coating composition is obtainable by the method as described in point 44.
46. A method for producing seed furnished with a coating, preferably seed in the form of seed grains or the like, having antistatic and/or electrically conductive and/or electrodissipative properties, where the seed is furnished and/or more particularly coated with a seed coating composition as defined in any of points 1 to 40 and/or in point 45.
47. The method as described in point 46, where the coating is obtained by bringing the seed coating composition, more particularly by applying and/or spraying the seed coating composition, onto the seed, more particularly followed by drying and/or curing of the seed coating composition.
48. Seed, more particularly seed in the form of seed grains or the like, where the seed is furnished with at least one antistatic and/or electrically conductive and/or electrodissipative coating, where the coating has or consists of a seed coating composition, more particularly as defined in any of points 1 to 40 and/or in point 45.
49. The seed as described in point 48, where the coating is disposed as outermost coat on the seed and/or where the coating at least substantially fully surrounds and/or envelops the seed, and/or where the coating is at least substantially continuous in form.
50. The seed as described in point 48 or 49, where the coating has a coat thickness in the range from 1 nm to 5 mm, more particularly in the range from 2 nm to 4 mm, preferably in the range from 5 nm to 3 mm, more preferably in the range from 10 nm to 2 mm, very preferably in the range from 100 nm to 1 mm, especially preferably in the range from 1000 nm to 0.5 mm.
51. The seed as described in any of points 48 to 50,

where the coating has a specific surface resistance σₛ of at most 10¹² Ω/sq, more particularly at most 10¹¹ Ω/sq, preferably at most 10¹⁰ Ω/sq, more preferably at most 10⁹ Ω/sq, very preferably at most 10⁸ Ω/sq and/or

where the coating has a specific surface resistance σₛ in the range from 10⁻³ Ω/sq to 10¹² Ω/sq, more particularly in the range from 10⁻¹ Ω/sq to 10¹¹ Ω/sq, preferably in the range from 10⁰ Ω/sq to 10¹⁰ Ω/sq, more preferably in the range from 10¹ Ω/sq to 10⁹ Ω/sq, very preferably in the range from 10² Ω/sq to 10⁸ Ω/sq.
52. The seed as described in any of points 48 to 51,

where the coating has a specific resistance ρₛ and/or a resistivity of at most 10¹⁰ Ω·m, more particularly at most 10⁵ Ω·m, preferably at most 10³ Ω·m and/or

where the coating in the dried and/or cured state has a specific resistance σₛ and/or a resistivity in the range from 10⁻⁷ Ω·m to 10¹⁰ Ω·m, more particularly in the range from 10⁻⁶ Ω·m to 10⁵ Ω·m, preferably in the range from 10⁻⁵ Ω·m to 10³ Ω·m.
53. The seed as described in any of points 48 to 52,

where the seed has a particle size and/or grain size, more particularly an average particle size and/or grain size D50, in the range from 0.01 mm to 5 cm, more particularly in the range from 0.05 mm to 2 cm, preferably in the range from 0.1 mm to 1 cm, more preferably in the range from 0.2 mm to 5 mm, very preferably in the range from 0.3 mm to 3 mm, especially preferably 0.5 mm to 2 mm and/or

where the seed has a thousand kernel mass (TKM) in the range from 0.01 g to 1000 g, more particularly 0.05 g to 800 g, preferably 0.1 g to 500 g, more preferably 0.3 g to 300 g, very preferably 0.5 g to 100 g, especially preferably 0.5 g to 50 g.
54. The seed as described in any of points 48 to 53, where the seed is selected from the group of vegetable seed, cereal seed, and ornamental-plant seed, more particularly flower seed.

### BRIEF DESCRIPTION OF THE DRAWINGS

FIG. 1 shows a schematic cross section of seed of the invention corresponding to a first embodiment;

FIG. 2 shows a schematic cross section of seed of the invention according to a further inventive embodiment;

FIG. 3 shows a photograph for documenting the antistatic behavior of inventive seed (FIG. 3A) in comparison to the electrostatic behavior of noninventive seed (FIG. 3B).

### DETAILED DESCRIPTION OF THE INVENTION

Provided by the present invention accordingly—according to a first aspect of the present invention—is a seed coating composition, more particularly for the furnishing of seed, preferably seed in the form of seed grains or the like, with at least one antistatic and/or electrically conductive and/or electrodissipative coating. A feature of the seed coating composition of the invention is that the coating composition has at least one at least substantially metal-free, preferably metal-free, electrically conductive additive.

The applicant, indeed, has discovered, in an entirely surprising way, that the purposive use of an at least substantially metal-free, preferably metal-free, and at the same time electrically conductive additive in the seed coating composition of the invention leads to outstanding electrostatic properties in the seed coated with the coating composition of the invention, since the coating composition of the invention as such has outstanding antistatic and/or electrically conductive and/or electrodissipative properties.

As a result of the specific furnishing of seed with the coating composition of the invention, electrostatic charging of the seed during processing and also during use is avoided, in particular, resulting in advantages specific both to method and to application. Indeed, the specific furnishing of the seed with the aforementioned properties has the effect of preventing or significantly reducing, for example, electrostatic charging of the seed brought about by movement or friction of the seed, meaning that the seed does not adhere or “stick”, for example, to processing equipment or portioning equipment. On the basis of the coating composition of the invention, moreover, uniform and continuous application to the seed is possible, resulting in uniform coat thicknesses.

On the basis of the overall outstanding antistatic properties of the seed coating composition of the invention and of the seed furnished therewith, improved discharge of the seed from (surrounding) packaging, and also outstanding singularization in the context of the use or sowing, are possible. These advantages are also governed by the outstanding free-flow capacity of the inventively furnished seed.

Through the specific properties of the coating composition of the invention, as recited above, therefore, electrostatic charging of the seed furnished with the coating composition is prevented overall.

Because of the use of the at least substantially metal-free, preferably metal-free, and also electrically conductive additives recited in accordance with the invention, good electrical conductivities result, especially in relation to the coating composition applied to a seed and present in particular in the dried or cured state. Against this background it is also possible to realize thin and uniform coat thicknesses.

A further key advantage of the inventive design can be seen, moreover, in the electrically conductive additive being at least substantially metal-free, preferably metal-free, and also at least substantially free, preferably free, from heavy metals. Where one result of this is to ensure high environmental compatibility, and another is that food-specific requirements are met to a high degree by the coating composition of the invention. More particularly, in accordance with the invention, the incorporation of metals, or heavy metals, into the germinating plant and subsequently their supply to the food chain are avoided. The coating composition of the invention therefore exhibits high environmentally specific and food-specific compatibility.

A further advantage of the present invention, moreover, lies in the fact that the seed coating composition of the invention is non-hygroscopic, and so there are no instances of excessive water incorporation into the resulting coat structures, especially under adverse processing conditions and/or storage conditions, more particularly in relation to a high ambient or atmospheric humidity. Accordingly, premature germination or infestation with (mold) fungi or the like is counteracted.

The term “antistatic”, as it is understood in the context of the present invention, relates in particular to the prevention or reduction of electrostatic charging caused in particular by friction, more particularly by virtue of partition or separation of corresponding charge carriers, in the seed coating composition of the invention and in the seed furnished therewith. Reduced electrostatic charging may be accomplished in ways including the inducement of charge compensation, as for example by contacting of the seed grain with a corresponding structure capable of charge compensation, and/or by dissipation of electrical charges.

Furthermore, the term “electrically conductive” or “conductive”, as it is used in the context of the present invention, refers more particularly to the capacity of the seed coating composition of the invention or of the resulting coating to conduct electrical current. As further recited below, this electrical conductivity results in particular from the availability of electrical charge carriers, more particularly electrons or delocalized electrons, in the parent coating system and/or in the additive used in accordance with the invention. The term “electrically conductive” or “conductive”, in the context of the present invention, is to be understood broadly and pertains in general to those electrical properties summarized in accordance with DIN EN ISO 61340-5-1 as “antistatic”, “statically conductive”, “conductive”, and also “conducting”. In this respect, reference may also be made to observations below.

Furthermore, the term “electrodissipative”, as it is used in the context of the present invention, refers in particular to the capacity for dissipation of electrical charges, thereby preventing any electrostatic charging as such.

Without wanting to be confined to this theory, the aforementioned properties are achieved in particular through the use in the context of the present invention of a specific conductive additive which is added to the coating composition of the invention. The coating composition may have a matrix structure or carrier structure in which the electrically conductive additive is incorporated. Overall, therefore, a conductive structure or matrix is formed within the seed coating composition according to the invention.

Furthermore, the term “metal-free”, as it is used in the context of the present invention for the electrically conductive additive, should be understood to mean that the additive as such has no metal ions and/or heavy metal ions and more particularly no metal oxides and/or heavy-metal oxides or metal-oxidic or heavy-metal-oxidic components or structures. Furthermore, the term in question should be understood to mean that the electrically conductive additive used in accordance with the invention also comprises no metal-doped or heavy-metal-doped compounds or salts. Achieved as a result are not only outstanding environmental compatibility but also high food compatibility on the part of the seed coating composition of the invention.

Moreover, the term “at least substantially metal-free”, as it is used in accordance with the invention also for the electrically conductive additive, should be understood to mean that the additive as such may have at most small amounts, or traces, of metals or metal components, in particular as recited above. The term in question pertains more particularly, for example, to production-related residues of metal in the additive, as for example catalyst residues or the like, and/or to any metal doping of the additive. In this context, the electrically conductive additive may at most have a metal content, more particularly a heavy metal content, of at most 1 wt %, more particularly at most 0.1 wt %, preferably at most 0.01 wt %, more preferably at most 0.001 wt %, very preferably at most 0.0001 wt %, especially preferably at most 0.00001 wt %, based on the additive. As recited above, the metal content recited above (if present at all) is formed in particular by production-related metal impurities or metal residues (e.g., from catalysts) and/or by metal doping of the electrically conductive additive.

According to one inventively preferred embodiment, the conductive additive as such is salt-free, more particularly ammonium salt-free, and/or nonhygroscopic and/or free from amino groups and/or free from ether groups. By virtue of the preferably salt-free structure and/or of the nonhygroscopic properties of the electrically conductive additive, excessive incorporation of water into the dried or cured coating composition applied to the seed is prevented, in particular, in accordance with the invention.

In accordance with the invention, moreover, particularly good antistatic properties in respect of the coating composition of the invention are achieved if the conductive additive is an electrically conductive carbon allotrope and/or an electrically conductive polymer.

Indeed, the electrically conductive additives in question, based on carbon allotropes and/or conductive organic polymers, which will be characterized in more depth hereinafter, are more particularly at least substantially metal-free, preferably metal-free, compounds which on account of their specific electrical properties lead to the antistatic furnishing of the coating composition of the invention and at the same time have a high environmental compatibility. Moreover, the compounds in question are advantageous in so far as they also exhibit high compatibility in relation to the further ingredients of the coating composition of the invention, and can be incorporated or worked effectively, moreover, into the coating composition, leading to stable coating compositions. By virtue of the high compatibility of the additives employed, furthermore, it is possible for numerous other specific ingredients to be used, as defined hereinafter, resulting overall in coating compositions, on the basis of the concept of the invention, that are adapted to the particular requirements of use and therefore, so to speak, are tailor-made.

Furthermore, the conductive additive, more particularly the conductive carbon allotrope and/or the conductive polymer, ought to have conjugated aromatic systems and/or conjugated double bonds and/or conjugated n electron systems.

The reason, without wishing to be confined to this theory, is that the electrical conductivity of the conductive additive employed in accordance with the invention may also be made possible in particular by conjugated double bonds, in other words, in particular, by the alternating sequence of double bonds and single bonds. In these conjugated systems, the p orbitals which form the respective double bond overlap with p orbitals which form the subsequent double bond, meaning that the individual n bonds within these conjugated systems are no longer localizable and there is what is called a delocalized n electron system present. In the conductive additives used in accordance with the invention, the n bonds are preferably delocalized over the entire length of the additive, with the possible consequent presence of a quasi-one-dimensional or multidimensional electronic system, resulting in the high electrical conductivity of the conductive additives employed in accordance with the invention, without any need for metallic components or the like in this respect.

In this context, the conductive additive, more particularly the conductive carbon allotrope and/or the conductive polymer, ought preferably to be capable of forming electrically conductive aggregates and/or electrically conductive networks. This may take place not least owing to the incorporation into a matrix structure or the like on which the coating composition of the invention is based.

Generally speaking, in the context of the present invention, the conductive additive, more particularly the conductive carbon allotrope and/or the conductive polymer, ought to have an electrical conductivity or conductance in the range from 10⁻¹³ to 10⁵ S/cm, more particularly 10⁻¹² to 10⁴ S/cm, preferably 10⁻¹⁰ to 10³ S/cm.

With regard, furthermore, to the conductive additive, more particularly the conductive carbon allotrope and/or the conductive polymer, preferably the conductive carbon allotrope, it ought to be particle-shaped and/or particulate in form. In this context, the conductive additive may—by way of example and without restriction—be granular, spherical, expanded, lamellar, flakelike, cylindrical, conical, or frustoconical in form. Structures of these kinds can be incorporated or introduced particularly effectively into the coating composition of the invention, while ensuring a high electrical conductivity. The relevant particle size of the conductive additive employed in accordance with the invention is also important in relation to the coating composition of the invention: thus the conductive additive, more particularly the conductive carbon allotrope and/or the conductive polymer, preferably the conductive carbon allotrope, ought to have an average particle size, more particularly an average particle size D50, in the range from 0.05 nm to 1000 μm, more particularly 0.1 nm to 800 μm, preferably 1 nm to 600 μm, more preferably 10 nm to 500 μm.

With regard to the determination of the particle size in general, it may be undertaken by the skilled person using methods that are well-known per se. The particle sizes in general may more particularly be determined using determination methods based on X-ray diffraction and laser diffractometry and also by light microscopy, electron microscopy, or the like. The size figures recited above in general for the conductive additive pertain in particular to an at least substantially spherical basic structure. In so far as the particles in question deviate from a spherical basic structure or from a spherical form, the size figures in question may relate to an assumed spherical form which has an identical volume to the underlying particles deviating from the spherical form. In this context, reference may be made in particular to Rawle, A., “Basic Principles of Particle-Size Analysis”, Surface Coatings International, Part A, Issue 2003/02. Reference is also made to the observations below concerning size determination of the additives that are each particularized further.

In the text below, a further description is given of the conductive additive in the form of conductive carbon allotropes that is used in one inventively preferred embodiment.

According to a preferred embodiment, in this context the conductive carbon allotrope used in accordance with the invention may be particle-shaped and particulate in form.

Moreover, the conductive carbon allotrope, based in particular on the individual particles, may be granular, spherical, expanded, lamellar, flakelike, cylindrical, conical, or frustoconical in form.

Moreover, the conductive carbon allotrope may have an average particle size D50 in the range from 0.05 nm to 1000 μm, more particularly 0.1 nm to 800 μm, preferably 1 nm to 600 μm, more preferably 10 nm to 500 μm. In this regard, reference may be made to observations above.

Furthermore, the conductive carbon allotrope, based on the individual particles of the carbon allotrope, may have an aspect ratio, calculated as the ratio of the width to the height of the particles, in the range from 1 to 10 000, more particularly greater than 1, preferably greater than 10, more preferably greater than 100. This applies in particular to specific forms, deviating from the spherical form, of the carbon allotropes in question, such as carbon nanotubes (CNTs), for example.

In accordance with the invention, the carbon allotrope may be selected from the group of
(i) optionally modified graphites, more particularly at least partly oxidized and/or fully or partly intercalated graphites and expandable graphites;
(ii) optionally modified graphenes, more particularly single-layer or multilayer graphenes (Few Layer Graphenes), graphene strips, and doped graphenes;
(iii) fullerenes, more particularly C₆₀ fullerene, C₇₀ fullerene, C₇₆ fullerene, C₈₀ fullerene, C₈₂ fullerene, C₈₄ fullerene, C₈₆ fullerene, C₉₀ fullerene, and C₉₄ fullerene, preferably C₆₀ fullerene and C₇₀ fullerene;
(iv) optionally modified carbon nanotubes (CNTs), more particularly doped and/or functionalized carbon nanotubes, single-wall carbon nanotubes (SWCNTs), multiwall carbon nanotubes (MWCNTs), carbon nanotubes with bamboo structure, and cup-stacked carbon nanotubes (CSCNTs);
(v) carbon blacks, more particularly Conductive Carbon Black;
(vi) carbon fibers;
(vii) optionally modified Carbon Nanohorns (CNHs), more particularly single-wall, double-wall, and multiwall Carbon Nanohorns;
(viii) Carbon Nanocones (CNCs);
(ix) Onion-Like Carbons (OLCs); and combinations or mixtures thereof.

According to one inventively preferred embodiment, therefore, conductive carbon allotropes used may be, more particularly, graphites, graphenes, fullerenes, carbon nanotubes (CNTs) and/or carbon blacks. As conductive carbon allotropes it is possible more particularly to use carbon nanotubes (CNTs) and/or carbon blacks.

The conductive carbon allotropes used in accordance with the invention may optionally be functionalized. Such functionalizations are known in principle to the skilled person, and so no further observations are required in this regard.

With regard to (i) the optionally modified graphites specifically, they may have an average particle size, more particularly an average particle size D50, based on the width of the individual graphite particles, in the range from 0.01 μm to 100 μm, more particularly 0.1 μm to 50 μm, preferably 1 μm to 30 μm.

The graphites used in accordance with the invention may, moreover, be natural or synthetic graphites. In this context, the optionally modified graphites may have an average particle size, more particularly an average particle size D50, based on the height of the individual graphite particles, in the range from 0.5 nm to 1000 nm, more particularly 1 nm to 500 nm, preferably 5 nm to 100 nm. The height here pertains in particular to the extent perpendicular to the corresponding carbon coats or basal planes of the graphite.

Furthermore, (i) the optionally modified graphites may have a specific surface area (BET surface area) in the range from 10 m²/g to 2000 m²/g, more particularly 15 m²/g to 1800 m²/g, preferably 20 m²/g to 1700 m²/g, more preferably 50 m²/g to 1600 m²/g.

The BET determination of the specific surface area is known fundamentally per se to the skilled person. All BET surface area figures may be determined in accordance with DIN ISO 9277:2003-05, “Determination of the specific area of solids by gas adsorption by the BET method (ISO 9277:1995)”. For further details concerning the determination of the BET surface area and/or concerning the BET method, reference may be made to Römpp Chemielexikon, 10th edition, Georg Thieme-Verlag, Stuttgart/New York, entry heading: “BET Method”, including the references cited therein, and to Winnacker-Küchler (3rd edition), Volume 7, pages 93 ff., and also to Z. Anal. Chem., 238, pages 187-193 (1968). Reference may be made, moreover, to the scientific publication of S. Brunnauer, P. H. Emmett, and E. Teller: “Adsorption of gases on multimolecular layers”, Journal of the American Chemical Society, 60, No. 2, 1938, pages 309 to 319.

Furthermore, (ii) the optionally modified graphenes may specifically be used in the form of multilayer graphenes. In this respect the graphenes may have up to 100 layers, more particularly 1 to 100 layers, preferably 1 to 50 layers, more preferably 1 to 30 layers, very preferably 1 to 20 layers, especially preferably 1 to 10 layers.

The graphites (i) and graphenes (ii) used in accordance with the invention may independently of one another have an oil absorption in the range from 10 to 750 ml/100 g, more particularly 15 to 600 ml/100 g, preferably 20 to 500 ml/100 g.

The oil absorption number (Oil Absorption Number, OAN) may in general be determined in particular on the basis of ISO 4656:2012. The corresponding ASTM method is ASTM D2414.

The determination of the size of (i) individual graphite particles and/or of (ii) individual graphene particles is accessible in particular by way of electron microscopy experiments. Since electron microscopy is an imaging procedure, individual particles may be measured accordingly.

With regard, furthermore, to the fullerenes (iii) employed in accordance with the invention, specifically, they may have a particle diameter in the range from 7 Å to 15 Å. The particle diameter of 7 Å refers in particular to C₆₀ fullerene. Higher fullerenes have a correspondingly larger diameter.

With regard specifically to the carbon nanotubes (CNTs) (iv) used in accordance with the invention, they may be used in the form of single-wall carbon nanotubes (SWCNTs) or multiwall carbon nanotubes (MWNTs). In this context, the multiwall carbon nanotubes (MWNTs) may be selected from 2- to 30-wall, preferably 3- to 15-wall, carbon nanotubes.

Furthermore, (iv) the carbon nanotubes (CNTs) used may have average internal diameters in the range from 0.4 to 50 nm, more particularly in the range from 1 to 10 nm, preferably in the range from 2 to 6 nm. Moreover, the carbon nanotubes (CNTs) used may have average external diameters in the range from 1 to 60 nm, more particularly in the range from 5 to 30 nm, preferably in the range from 10 to 20 nm. Additionally, the carbon nanotubes (CNTs) used may have average lengths in the range from 0.01 to 1000 μm, more particularly in the range from 0.1 to 500 μm, preferably in the range from 0.5 to 200 μm, more preferably in the range from 1 to 100 μm.

The size determination of the inventively employed carbon nanotubes (CNTs) may be made in particular on the basis of measurement of singularized tubes by electron microscopy. Furthermore, the BET method may be employed as a support in the size determination.

With regard, moreover, to the carbon nanotubes (CNTs) used in accordance with the invention, they ought to have a specific electrical conductivity of at least 10³ S/cm, more particularly at least 0.5·10⁴ S/cm, preferably at least 10⁴ S/cm.

With regard, furthermore, (v) to the inventively employed carbon blacks specifically, they are notable in particular for the fact that they may be present in the form of aggregates composed of a multiplicity of individual particles. These aggregates may form widely branched structures, leading ultimately to the electrical conductivity of the carbon blacks.

In particular (v) the carbon blacks, more particularly the primary particles of the carbon black, may have an average particle size, more particularly an average particle size D50, in the range from 1 nm to 1000 nm, more particularly 10 nm to 800 nm, preferably 50 nm to 500 nm. In this context, the particle diameters recited above for the carbon blacks in question relate to the individual particles or primary particles of the aggregate-forming carbon blacks. The size determination may be made in particular on the basis of an electron microscope measurement.

Moreover (v) the carbon blacks may have a specific surface area (BET surface area) in the range from 10 m²/g to 2000 m²/g, more particularly 15 m²/g to 1800 m²/g, preferably 20 m²/g to 1700 m²/g, more preferably 50 m²/g to 1600 m²/g.

Lastly, (v) the carbon blacks may have an oil absorption in the range from 10 to 500 ml/100 g, more particularly 15 to 450 ml/100 g, preferably 20 to 400 ml/100 g. The oil absorption may be determined equally on the basis of ISO 4656:2012 or ASTM D2414.

With regard specifically to the carbon fibers (vi) used in accordance with the invention, they may have an average fiber diameter, more particularly an average fiber diameter D50, in the range from 1 μm to 20 μm, more particularly 2 μm to 15 μm, preferably 3 μm to 10 μm. In particular the carbon fibers may have an average fiber length, more particularly an average fiber length D50, in the range from 20 μm to 500 μm, more particularly 30 μm to 400 μm, preferably 50 μm to 300 μm. The size determination of the carbon fibers may be made for example by electron microscopy analyses. Furthermore, the BET method may also be employed for size determination.

With regard to the inventively employed (vi) carbon fibers, moreover, they may have an average fiber diameter, more particularly an average fiber diameter D50, in the range from 1 μm to 20 μm, more particularly 2 μm to 15 μm, preferably 3 μm to 10 μm. In particular the carbon fibers may have an average fiber length, more particularly an average fiber length D50, in the range from 20 μm to 500 μm, more particularly 30 μm to 400 μm, preferably 50 μm to 300 μm.

Lastly, (vi) the carbon fibers may have a specific electrical resistance ρ in the range from 10⁻³ Ω·m to 10⁻⁷ Ω·m, more particularly 10⁻⁴ Ω·m to 10⁻⁶ Ω·m.

With regard specifically, moreover, to (vii) the Carbon Nanohorns (CNHs), they may have average lengths in the range from 10 to 100 nm, more particularly in the range from 20 to 80 nm, preferably in the range from 40 to 50 nm. Furthermore, the Carbon Nanohorns (CNHs) may have average diameters in the range from 0.5 to 10 nm, more particularly in the range from 1 to 8 nm, preferably in the range from 1.5 to 5 nm, more preferably in the range from 2 to 3 nm. In particular the Carbon Nanohorns (CNHs) may have a specific surface area (BET surface area) in the range from 10 m²/g to 1500 m²/g, more particularly 15 m²/g to 1000 m²/g, preferably 20 m²/g to 800 m²/g, more preferably 50 m²/g to 500 m²/g. With regard to the respective methods for determination, reference may be made to observations above.

With specific regard, furthermore, to (viii) the Carbon Nanocones (CNCs), they may have an at least substantially conic form and/or be conical in form. In particular, the ratio of the base area diameter to the height of the Carbon Nanocones (CNCs) may be in the region of 1.

Moreover, (ix) the Onion-Like Carbons (OLCs) may be at least substantially spherical. Furthermore, (ix) the Onion-Like Carbons (OLCs) may have average particle sizes, more particularly average particle sizes D50, in the range from 5 nm to 50 nm, more particularly 5 nm to 30 nm, preferably 10 nm to 20 nm. For the methods of determination, reference may also be made to observations above.

In the text below, the polymers used as conductive additives in accordance with one further embodiment preferred in accordance with the invention are described:

The conductive polymers, which may also be referred to synonymously as electrically intrinsically conducting polymers, generally represent plastics with electrical conductivity.

In one inventively preferred embodiment, the conductive polymer may be selected from the group of polyacetylenes, polyanilines, polyparaphenylenes, polystyrenes, polythiophenes, polyethylenedioxy-thiophenes (PEDOT), polyethylenedioxythiophenes: polystyrenesulfonates (PEDOT:PSS), and polyphenylene-vinylenes, more particularly polyacetylenes, polyanilines, polyparaphenylenes, polystyrenes, and polythiophenes. The conductivity of the conductive polymers used in accordance with the invention may be controlled authoritatively by doping of the polymers with targeted chemical functionalization, allowing the desired conductivity to be tailored through the corresponding doping. The doping may be accomplished either by direct chemical functionalization, such as oxidation or incorporation of halogen atoms, or by addition of a further conductive polymer, as in the case of polyethylenedioxythiophene:polystyrenesulfonate (PEDOT:PSS), in which the polystyrenesulfonate functions as dopant.

In accordance with the invention, furthermore, it is also possible to use sulfonated polyaniline as conductive polymer, this polymer likewise having high conductivity and also water-solubility. Moreover, it is insoluble in organic solvents that are miscible with water, such as alcohols, resulting in the sulfonated polyaniline being dispersed as fine particles in the coating composition and hence in an improved antistatic effect on the part of the coating composition.

With regard in general to the determination of the conductivity and of the electrical resistance of the electrically conductive additives in question, they may also be determined, for example, by means of impedance spectroscopy, a technique known in principle to the skilled person.

With regard, furthermore, to the coating composition of the invention, it has proven particularly advantageous if the conductive additive used in this context is selected from the group of carbon blacks, graphites, graphenes, conductive polymers, carbon nanotubes (CNTs), fullerenes, and combinations thereof.

The amount of conductive additives in the coating composition of the invention may vary within wide ranges. The amount of conductive additives present in each of the coating compositions according to the invention is dependent on the particular end use, on the application conditions, and on the materials used. Particularly good results in terms of antistatic properties are obtained if the coating composition comprises the conductive additive, more particularly the electrically conductive carbon allotrope and/or the electrically conductive polymer, in amounts in the range from 0.0001 wt % to 70 wt %, more particularly 0.001 wt % to 60 wt %, preferably 0.01 wt % to 50 wt %, more preferably 0.1 wt % to 40 wt %, very preferably 0.2 wt % to 20 wt %, especially preferably 0.5 wt % to 15 wt %, more preferably still 1 wt % to 10 wt %, based on the composition.

With regard to the coating composition according to the invention as such, it may be present in the form of a dispersion, preferably an aqueous or aqueously based dispersion, and/or a solubilizate, more particularly an aqueous or aqueously based solubilizate. In this context, the conductive additive, more particularly the electrically conductive carbon allotrope and/or the electrically conductive polymer, may be incorporated in a continuous phase or in at least one carrier medium, more particularly dispersion medium or solubilization medium. Provision is made preferably in accordance with the invention for the coating composition to be in the form of a dispersion, preferably an aqueous or aqueously based dispersion. In accordance with the invention, moreover, the conductive additive, more particularly the electrically conductive carbon allotrope and/or the electrically conductive polymer, preferably the electrically conductive polymer, may be present at least partially in solution and/or in solubilized form in the coating composition, more particularly in the dispersion medium and/or solubilization medium, respectively. In this context the dispersion medium or solubilization medium may also function as solvent.

A dispersion in the context of the present invention means more particularly a mixture of at least two phases clearly delimited from one another which do not dissolve in one another, or at least not substantially. In the dispersions there is more particularly at least one phase, this being the dispersed or discontinuous phase, in very fine dispersion in another phase, i.e. the continuous phase, or the carrier medium or dispersion medium. Dispersions may in general take the form of mixtures of solid phases (solid/solid), solid and liquid phases (solid/liquid and liquid/solid), and also mixtures of gaseous phases with solid or liquid phases (liquid/gaseous, gaseous/liquid, or solid/gaseous). In the context of the present invention, solid/liquid systems are generally used, with a solid phase present in dispersion in a liquid carrier medium or dispersion medium; also possible in principle in accordance with the invention is the use of solid/solid dispersions. Regarding the concept of a dispersion, as used in the context of the present invention, reference may be made in particular to DIN 53900 (July 1972).

The concept of the solubilizate refers in the context of the present invention in the widest sense to solutions of substances or compounds, more particularly of macromolecules, which in general are not soluble in the respective carrier medium or solvent without the addition of auxiliaries or additives. For the dissolution and/or solubilization of these substances, the use of a solubilizer is advantageous in particular, this solubilizer influencing the solvency properties of the carrier medium or solvent and/or, for example, raising the solubility of the chemical substance or chemical compound in question—as in the case of formation of micelles by surfactants.

In the context of the present invention, the continuous phase and/or carrier medium used, more particularly the dispersion medium and/or solubilization medium used, may be an aqueously, organically or aqueous-organically based carrier medium, more particularly dispersion medium and/or solubilization medium, preferably an aqueously or aqueously organic carrier medium, more preferably an aqueously based carrier medium.

More particularly the continuous phase and/or carrier medium used may be a carrier medium which is present in the liquid aggregate state under dispersing and/or solubilizing conditions, more particularly under atmospheric pressure (101.325 kPa) and in a temperature range from 10 to 100° C., preferably 15 to 70° C. The carrier medium, more particularly the dispersion medium and/or the solubilization medium, may more particularly be selected from the group of (i) water; (ii) alcohols, more particularly straight-chain, branched, or cyclic, monohydric or polyhydric alcohols; (iii) ether alcohols; (iv) hydrocarbons; (v) ethers; (vi) carboxylic esters; (vii) ether esters; (viii) lactones; (ix) plasticizers, more particularly phthalates; (x) aldehydes and ketones; (xi) acid amides; (xii) N-methylpyrrolidone; and also combinations of the aforementioned carrier media.

In the context of the present invention, the dispersion medium or solubilization medium may also comprise water. In one inventively preferred embodiment, the dispersion medium and/or the solubilization medium ought to be water.

In the context of the present invention it is also possible in particular to use mixtures of dispersion media and/or solubilization media; for example, the dispersion media and/or solubilization media identified under (ii) to (xii) may to an extent be used as co-dispersion media or co-solubilization media together with water. For this case, the co-dispersion medium or co-solubilization medium employed in this context ought in particular to be dispersible or soluble in water. As co-dispersion media and co-solubilization media it is possible, for example, to use water-soluble organic solvents, such as methanol, ethanol, isopropanol and/or propanol.

In accordance with the invention, the coating composition may comprise the carrier medium, more particularly the dispersion medium and/or the solubilization medium, in amounts in the range from 0.1 wt % to 99 wt %, more particularly 1 wt % to 95 wt %, preferably 5 wt % to 90 wt %, more preferably 10 wt % to 80 wt %, very preferably 20 wt % to 60 wt %, based on the composition.

More particularly the coating composition may comprise the carrier medium, more particularly the dispersion medium and/or the solubilization medium, in amounts in the range from 10 wt % to 1000 wt %, more particularly 25 wt % to 500 wt %, preferably 50 wt % to 400 wt %, more preferably 75 wt % to 350 wt %, very preferably 100 wt % to 300 wt %, especially preferably 150 wt % to 250 wt %, based on the conductive additive, more particularly the electrically conductive carbon allotrope and/or the electrically conductive polymer.

With regard to the dispersion medium or the solubilization medium as such, it may be removed substantially completely from the coating composition, more particularly as part of the drying and/or curing of the coating composition according to the invention applied to the seed, such removal taking place, for example, by air drying or the like.

Furthermore, the coating composition may comprise at least one dispersant and/or wetting agent, more particularly a polymeric dispersant and/or wetting agent, preferably based on a functionalized polymer, preferably having a number-average molecular mass of at least 500 g/mol, preferably at least 1000 g/mol, more preferably at least 2000 g/mol.

In this context the dispersant may be selected from the group of polymers and copolymers having functional and/or pigment-affinity groups, alkylammonium salts of polymers and copolymers, polymers and copolymers having acidic groups, comb copolymers and block copolymers, such as block copolymers having, in particular, basic pigment-affinity groups, optionally modified acrylate block copolymers, optionally modified polyurethanes, optionally modified and/or salinated polyamines, phosphoric esters, ethoxylates, polymers and copolymers with fatty acid radicals, optionally modified polyacrylates, such as transesterified polyacrylates, optionally modified polyesters, such as acid-functional polyesters, polyphosphates, and combinations thereof. On the basis of the dispersant and/or wetting agent employed in accordance with the invention, stable dispersions or solubilizates of the conductive additives used may be obtained, and in particular the amount of conductive additive in the coating composition according to the invention may also be increased further.

The concept of the dispersant—also referred to synonymously as wetting agent, dispersing agent, dispersing additive, etc.—as used in the context of the present invention refers in general to substances which facilitate the dispersing of particles in a carrier medium or dispersion medium, more particularly by lowering the interfacial tension between the two components—particles for dispersion, on the one hand, and dispersion medium, on the other—and thereby bringing about wetting. Consequently, a multiplicity of synonymous terms for dispersants (dispersing agents) are in use, such as dispersing additive, antisettling agent, wetting agent, detergent, suspension assistant and dispersion assistant, emulsifier, etc. The concept of the dispersant should not be confused with the concept of the dispersion medium, since the latter refers to the continuous phase or the carrier medium of the dispersion (i.e. the liquid, continuous dispersion medium).

For further details regarding the terms “disperser”, “dispersing”, “dispersant”, “disperse systems”, and “dispersion”, reference may be made, for example, to Römpp Chemielexikon, 10th edition, Georg Thieme-Verlag, Stuttgart/New York, Volume 2, 1997, pages 1014/1015, and also to references cited therein, the overall disclosure content thereof being hereby incorporated by reference.

The molecular weight of the dispersants or wetting agents used may be determined on the basis of a GPC method, more particularly based on DIN 55672 with polymethyl methacrylate or polystyrene as a standard.

Furthermore, as dispersants suitable in accordance with the invention, it is possible in principle to use all wetting agents, surfactants, dispersants, etc. known to the skilled person for this purpose.

In an inventively preferred way, dispersants selected are more particularly those compounds as described in publications EP 1 593 700 B1, EP 0 154 678 B1, EP 0 318 999 B1, EP 0 270 126 B1, EP 0 893 155 B1, EP 0 417 490 B1, EP 1 081 169 B1, EP 1 650 246 A1, EP 1 486 524 A1, EP 1 640 389 A1, EP 0 879 860 B1, WO 2005/097872 A1, and EP 1 416 019 A1, the respective disclosure content of which is hereby incorporated in full by reference. These compounds are described or defined more closely in Points of Novelty 14 to 19 (=EP 1 593 700 B1), Point of Novelty 20 (=EP 0 154 678 B1), Point of Novelty 21 (=EP 0 318 999 B1), Point of Novelty 22 (=EP 0 270 126 B1), Point of Novelty 23 (=EP 0 893 155 B1), Point of Novelty 24 (=EP 0 417 490 B1), Point of Novelty 25 (=EP 1 081 169 B1), Point of Novelty 26 (=EP 1 650 246 A1), Point of Novelty 27 (=EP 1 486 524 A1), Point of Novelty 28 (=EP 1 640 389 A1), Point of Novelty 29 (=EP 0 879 860 B1), Point of Novelty 30 (=WO 2005/097872 A1), and Point of Novelty 31 (=EP 1 416 019 A1).

With regard to the amount of dispersant and/or wetting agent in the coating composition of the invention, the coating composition may comprise the dispersant and/or wetting agent in amounts in the range from 0.1 wt % to 50 wt %, more particularly 0.5 wt % to 40 wt %, preferably 1 wt % to 30 wt %, more preferably 2 wt % to 10 wt %, based on the composition.

Moreover, the coating composition according to the invention may have at least one matrix substance and/or scaffold substance. In this context, the matrix substance and/or scaffold substance may be selected from the group of natural, nature-identical, and synthetic polymers, preferably water-soluble and/or water-dispersible polymers. Equally the matrix substance or scaffold substance may be selected from the group of methylcellulose, carboxymethylcellulose, hydroxypropylcellulose, alginate, gelatin, casein, polyurethanes, polyacrylates, polyacrylamides, polyvinyl alcohols, polyvinyl acetates, polyvinyl-pyrrolidones, and waxes, more particularly beeswax, carnauba wax, polyethylene wax, and polypropylene wax, and combinations thereof.

The matrix and scaffold substances used in accordance with the invention serve in particular for matrix construction and for incorporation of the conductive additive, and also, to a certain extent, to the build-up of mass of the coating composition of the invention.

Generally speaking, the coating composition may comprise the matrix substance and/or scaffold substance in amounts in the range from 0.5 wt % to 70 wt %, more particularly 1 wt % to 60 wt %, preferably 2 wt % to 50 wt %, more preferably 5 wt % to 20 wt %, based on the composition.

Furthermore, the coating composition according to the invention may have at least one thickener and/or one agent that increases the viscosity. In this context, the thickener or the agent that increases the viscosity may be selected from the group of pectins, alginates, tragacanth, gum arabic, guar gum, carrageenan, carboxymethylcellulose, carboxypropylcellulose, polyacrylates, polysaccharides, urea derivatives, and clays, more particularly bentonite clays, and combinations thereof.

In this context, the coating composition may comprise the thickener and/or the agent that increases the viscosity in amounts in the range from 0.001 wt % to 25 wt %, more particularly 0.01 wt % to 10 wt %, preferably 0.05 wt % to 5 wt %, more preferably 0.1 wt % to 4 wt %, very preferably 0.5 wt % to 2 wt %, based on the composition.

The thickener or the agent that increases the viscosity serves more particularly for adjusting the viscosity in so far as in this way it is possible for optimum production and/or processing of the coating composition and/or for uniform coating of the seed with the coating composition to be accomplished.

Furthermore, the coating composition may have at least one defoamer. In this respect, the defoamer may be selected from the group of polyethers, polyacrylates, glycerol, polyethylene glycol, and polysiloxanes, and combinations thereof.

The coating composition may comprise the defoamer in this case in amounts in the range from 0.001 wt % to 3 wt %, more particularly 0.01 wt % to 2 wt %, preferably 0.1 wt % to 1 wt %, more preferably 0.2 wt % to 1 wt %, based on the composition.

Furthermore, provision may be made in accordance with the invention for the coating composition to comprise at least one granulating assistant. In this respect the granulating assistant may be a wax, more particularly beeswax, carnauba wax, polyethylene wax and/or polypropylene wax.

Furthermore, provision may be made in the context of the present invention for the coating composition to comprise at least one pelletizer or mass-forming substance. In this context, the pelletizer, in a nonlimiting way, may be peat, clay and/or starch.

Furthermore, the coating composition may comprise at least one further additive and/or at least one further ingredient. In this context, the further additive may be selected from the group of fillers, more particularly carbonates, preferably calcium carbonate; granulating agents; adhesion promoters; rheology modifiers; pH modifiers; antiblocking and/or antistick agents, more particularly waxes; plasticizers; UV adsorbers; flow control agents; dyes and color pigments; and combinations thereof.

Moreover, the coating composition may comprise the further additive and/or the further ingredient in amounts in the range from 0.0001 wt % to 40 wt %, more particularly 0.001 wt % to 30 wt %, preferably 0.01 wt % to 20 wt %, more preferably 0.1 wt % to 15 wt %, based on the composition.

According to one inventively preferred embodiment, the coating composition may further comprise at least one biologically active ingredient. In that case the biologically active ingredient may be selected from the group of biocides, more particularly fungicides, herbicides, bactericides, insecticides, microbicides, molluscicides, and virucides; fertilizers; nutrients; vitamins; germination and/or growth regulators, more particularly hormones, preferably phytohormones; and combinations thereof.

In this context, the coating composition may comprise the biologically active ingredient in amounts in the range from 0.0001 wt % to 20 wt %, more particularly 0.001 wt % to 15 wt %, preferably 0.01 wt % to 10 wt %, more preferably 0.1 wt % to 5 wt %, based on the composition.

Targeted use of the ingredients in question may further improve the germination characteristics and/or plant growth.

In accordance with the invention, moreover, provision may be made for the coating composition as such as well to be at least substantially metal-free, more particularly metal-free, preferably heavy metal-free, or at least of low-metal-content, more particularly of low-heavy-metal-content, in form. In this context the coating composition may have at most a metal content, more particularly a heavy metal content, of at most 0.1 wt %, more particularly at most 0.01 wt %, preferably at most 0.001 wt %, more preferably at most 0.0001 wt %, very preferably at most 0.00001 wt %, especially preferably at most 0.000001 wt %, based on the composition. The metal content in question may comprise, for example, catalyst residues or the like. In view of the inventively preferred embodiment whereby the coating composition of the invention is metal-free or heavy metal-free or at least of low metal content or low heavy metal content in form, the coating composition according to the invention as such exhibits a high environmental compatibility and/or food compatibility.

In this context, provision may equally be made in accordance with the invention for the coating composition to be at least substantially free from metal-containing pigments and/or metal-like dyes.

The coating composition according to the invention as such, moreover, may have a fluid and/or liquid consistency, in particular under processing and/or use conditions, more particularly under atmospheric pressure (101.325 kPa) and in a temperature range from to 100° C., preferably 15 to 70° C. As a result in accordance with the invention, optimum processing and/or application is possible, with subsequent drying or curing of the coating composition on the seed to be treated. As recited above, the viscosity or rheology may be adjusted or tailored, leading to a further improvement in the processing and/or use of the coating composition of the invention.

In this context it is preferred in accordance with the invention if the coating composition, more particularly under processing and/or use conditions, more particularly under atmospheric pressure (101.325 kPa) and in a temperature range from 10 to 100° C., preferably 15 to 70° C., has a dynamic viscosity in the range from to 50 000 mPa·s, more particularly 25 to 30 000 mPa·s, preferably 50 to 25 000 mPa·s, more preferably 75 to 20 000 mPa·s.

The viscosity of the coating composition of the invention may be determined in particular on the basis of DIN 53019.

The coating composition in the dried or cured state may have a total residual moisture content in the range from 0.001 to 5 wt %, more particularly 0.01 to 3 wt %, preferably 0.1 to 2 wt %, more preferably 0.2 to 1 wt %, based on the coating composition.

Accordingly the coating composition according to the invention, in the dried or cured state, ought to have a total residual moisture content of at most 5 wt %, more particularly at most 3 wt %, preferably at most 2 wt %, more preferably at most 1 wt %, based on the coating composition.

As recited above, by virtue of the purposive use of an electrically conductive additive, the coating composition of the invention is distinguished by the fact that this composition as such is electrically conductive or has antistatic properties or electrodissipative properties.

In this context it is preferred in accordance with the invention if the coating composition according to the invention in the dried and/or cured state has a specific surface resistance σₛ of at most 10¹² Ω/sq, more particularly at most 10¹¹ Ω/sq, preferably at most 10¹⁰ ΩQ/sq, more preferably at most 10⁹ Ω/sq, very preferably at most 10⁸ Ω/sq.

This specific surface resistance σₛ is so to speak a measure of the property of the coating composition of withstanding an electrical surface current which flows along on the surface of the coating composition. In this context, the specific surface resistance ρₛ constitutes a characteristic variable in relation to the electrostatic properties of the underlying material.

In accordance with the underlying DIN EN ISO 61340-5-1, the electrical properties of the coating composition of the invention in the dried or cured state may be classed such that the composition is statically dissipating, statically conductive, or conductive or conducting. A statically dissipative composition in this respect is a composition having a specific surface resistance σₛ in the range from 10⁹ Ω/sq to 10¹² Ω/sq. Correspondingly, a composition is considered statically conductive if it has a specific surface resistance σₛ in the range from 10⁶ Ω/sq to 10⁹ Ω/sq, while a composition having a specific surface resistance σₛ in the range from 10² Ω/sq to 10⁵ Ω/sq is termed conductive. A composition with a further reduced specific surface resistance σₛ, accordingly, will be referred to as a conducting composition.

For the purposes of the present invention, the specific surface resistance σₛ may be determined on the basis of the relevant DIN EN 61340-2-3:2000.

With regard, furthermore, to the electrical properties of the coating composition of the invention, the coating composition in the dried and/or cured state may have a specific resistance ρₛ and/or a resistivity of at most 10¹⁰ Ωm, more particularly at most 10⁵ Ωm, preferably at most 10³ Ω·m.

In this context, the composition of the invention ought therefore in the dried and/or cured state to have a specific resistance ρₛ and/or a resistivity in the range from 10⁻⁷ Ω·m to 10¹⁰ Ω·m, more particularly in the range from 10⁻⁶ Ω·m to 10⁵ Ω·m, preferably in the range from 10⁻⁵ Ω·m to 10³ Ω·m.

The specific resistance σₛ may equally be determined on the basis of the above-recited DIN EN 61340-2-3: (2000 December).

The defined electrical properties of the coating composition of the invention result overall in outstanding antistatic properties for the seed furnished with the coating composition.

Further provided by the present invention, moreover—according to a second aspect of the present invention—is the use of at least one at least substantially metal-free, preferably metal-free, electrically conductive additive, more particularly of an electrically conductive carbon allotrope and/or of an electrically conductive polymer, preferably as defined above, for producing an antistatic and/or electrically conductive and/or electrodissipative seed coating composition and/or seed coating.

Additionally provided by the present invention, furthermore—in accordance with a third aspect of the present invention—is the inventive use of at least one at least substantially metal-free, preferably metal-free, electrically conductive additive, more particularly of an electrically conductive carbon allotrope and/or of an electrically conductive polymer, preferably as defined above, for the antistatic and/or electrically conductive and/or electrodissipative furnishing of seed and/or for the antistatic and/or electrically conductive and/or electrodissipative furnishing of a seed coating.

Further provided by the present invention in turn—in accordance with a fourth aspect of the present invention—is the use of a coating composition for the antistatic and/or electrically conductive and/or electrodissipative furnishing of seed, where the coating composition has at least one at least substantially metal-free, preferably metal-free, electrically conductive additive, more particularly an electrically conductive carbon allotrope and/or an electrically conductive polymer, preferably as defined above.

Further provided by the present invention more particularly—in accordance with a fifth aspect of the present invention—is the method of the invention for producing an antistatic and/or electrically conductive and/or electrodissipative seed coating composition, more particularly for the furnishing of seed, where at least one at least substantially metal-free, preferably metal-free, electrically conductive additive, more particularly an electrically conductive carbon allotrope and/or an electrically conductive polymer, preferably as defined above, is dispersed in a continuous phase and/or in a carrier medium, more particularly dispersion medium and/or solubilization medium, preferably in the presence of at least one dispersant and/or wetting agent, with introduction of an energy input sufficient for dispersing.

The dispersions forming the basis of the coating composition of the invention, said dispersions comprising the conductive additive used in accordance with the invention, particularly in the form of carbon nanotubes (CNTs), and able to be used in the context of the present invention, are obtainable, for example, by the method described in DE 10 2006 055 106 A1, in WO 2008/058589 A2, in US 2010/0059720 A1, and in CA 2,668,489 A1, the respective disclosure content of which is fully incorporated by reference. The aforesaid documents relate to a method for dispersing carbon nanotubes (CNTs) in a continuous phase, more particularly in at least one dispersion medium, in which the carbon nanotubes (CNTs), more particularly without prior pretreatment, are dispersed in a continuous phase, more particularly in at least one dispersion medium, in the presence of at least one dispersant (dispersing agent) with introduction of an energy input sufficient for dispersing. The amount of energy introduced during the dispersing operation, calculated as input energy per unit amount of carbon nanotubes (CNTs) to be dispersed, may be in particular 15 000 to 100 000 kJ/kg; dispersants used may be, in particular, polymeric dispersants, preferably based on functionalized polymers, more particularly having number-average molecular masses of at least 500 g/mol. With these dispersing methods it is possible to obtain stable dispersions of carbon nanotubes (CNTs). The further active and other ingredients recited above may be added to the dispersions in question, moreover.

Further provided by the present invention in this context—in accordance with a sixth aspect of the present invention—is also the seed coating composition as such, more particularly for the antistatic and/or electrically conductive and/or electrodissipative furnishing of seed, said composition being obtainable by the method described above in accordance with the fifth aspect of the present invention.

As already observed above, the coating composition of the invention is notable for outstanding properties with regard to the dissipation of electrical charges, meaning that excellent antistatic properties are present overall. Furthermore, the coating composition of the invention may be modified or tailored in relation to the respective use requirements, not least by the addition of further ingredients. Moreover, the coating composition of the invention will be processed outstandingly, especially with regard to the application and/or the coating of seed. The composition of the invention is notable, moreover, for a high storage stability.

Further provided by the present invention, moreover—in accordance with a seventh aspect of the present invention—is the method for producing seed furnished with a coating, preferably seed in the form of seed grains or the like, with antistatic and/or electrically conductive and/or electrodissipative properties. In this context the seed is furnished and/or coated with the seed coating composition of the invention as defined above.

In this context, the coating may take place for example by contacting, more particularly application or spraying, of the seed coating composition, more particularly in the liquid or flowable and/or in the undried or uncured state, to the seed. In this regard, there may subsequently be drying and/or curing of the seed coating composition.

The coating methods that can be used in this context are well known to the skilled person. In particular, for example, starting from aqueous dispersions based on the coating composition of the invention, methods may be used that are based on drum coating, more particularly using a mixer, spray application methods, dipping methods, or the like. The drying and/or curing of the composition of the invention may take place, for example, on the basis of air drying, optionally with gentle to moderate heating. The drying and/or curing may also encompass crosslinking or polymerization of polymerizable components employed.

On the basis of the method of the invention, it is possible to produce electrically conducting and/or antistatic and also electrodissipative coats on seed in an efficient way. The method of the invention can be implemented cost-effectively and also on an industrial scale. On the basis of the method of the invention, moreover, durable and resistant coatings on seed are made possible, exhibiting a permanent antistatic or electrically conducting effect.

Lastly, the present invention relates—in accordance with an eighth aspect of the present invention—to the seed of the invention, more particularly seed in the form of seed grains or the like, where the seed is furnished with at least one antistatic and/or electrically conductive and/or electrodissipative coating, where the coating has or consists of a seed coating composition, more particularly as defined above.

In the context of the present invention, provision is made more particularly for the coating on the seed of the invention to have the coating composition according to the invention in dried and/or in cured form, as defined above.

According to a further inventively preferred embodiment, the coating is disposed as the outermost coat on the seed. Equally it is preferred in accordance with the invention for the coating to at least substantially completely surround or envelop the seed. In other words, it is of advantage in accordance with the invention if the coating is at least substantially continuous in form. By this means, the antistatic properties of the coating are further improved. Moreover, the aforementioned measures ensure optimum transport of electrical charges away, in order to prevent electrostatic charging.

The present invention is in general not confined to the formation of an individual coating or coat based on the coating composition of the invention. Instead, the seed of the invention may have a multiplicity of coatings based on the coating composition of the invention. Moreover, the seed of the invention may also have further coatings or coats, which as such do not possess electrostatic or electrically conducting properties, these coatings or coats being disposed preferably between the coating based on the coating composition of the invention, and the seed grain. The realization of a plurality of coats is associated with the advantage that coats different from one another in each case can be applied, each having specific properties, allowing a further tailoring or adaptation to the particular profile of requirements in this respect.

With regard to the coating as such, moreover, it ought to have a coat thickness in the range from 1 nm to 5 mm, more particularly in the range from 2 nm to 4 mm, preferably in the range from 5 nm to 3 mm, more preferably in the range from 10 nm to 2 mm, very preferably in the range from 100 nm to 1 mm, especially preferably in the range from 1000 nm to 0.5 mm.

With regard to the electrical properties of the coating or of the applied coat as such, the coating ought to have a specific surface resistance σₛ of at most 10¹² Ω/sq, more particularly at most 10¹¹ Ω/sq, preferably at most 10¹⁰ Ω/sq, more preferably at most 10⁹ Ω/sq, very preferably at most 10⁸ Ω/sq. In this context, moreover, the coating ought to have a specific surface resistance σₛ in the range from 10⁻³ Ω/sq to 10¹² Ω/sq, more particularly in the range from 10⁻¹ Ω/sq to 10¹¹ Ω/sq, preferably in the range from 10⁰ Ω/sq to 10¹⁰ Ω/sq, more preferably in the range from 10¹ Ω/sq to 10⁹ Ω/sq, very preferably in the range from 10² Ω/sq to 10⁸ Ω/sq. In this respect, reference may equally be made to DIN EN 61340-2-3: (2000 December), as recited above.

The coating, moreover, ought to have a specific resistance ρₛ and/or a resistivity of at most 10¹⁰ Ω·m, more particularly at most 10⁵ Ω·m, preferably at most 10³ Ω·m.

In this context, provision may be made in accordance with the invention for the coating in the dried and/or cured state to have a specific resistance ρₛ and/or a resistivity in the range from 10⁻⁷ Ω·m to 10¹⁰ Ω·m, more particularly in the range from 10⁻⁶ Ω·m to 10⁵ Ω·m, preferably in the range from 10⁻⁵ Ω·m to 10³ Ω·m.

With regard, moreover, to the seed of the invention, the seed, i.e., the seed grains constituting the seed (i.e., the uncoated, separate seed grains as such), ought to have a particle size or grain size, more particularly an average particle size or grain size D50, in the range from 0.01 mm to 5 cm, more particularly in the range from 0.05 mm to 2 cm, preferably in the range from 0.1 mm to 1 cm, more preferably in the range from 0.2 mm to 5 mm, very preferably in the range from 0.3 mm to 3 mm, especially preferably 0.5 mm to 2 mm. The determination in this respect may take place for example by light microscopy or the like.

Furthermore, the seed, i.e., the seed grains constituting the seed (i.e., the uncoated, separate seed grains as such) ought to have a thousand kernel mass (TKM) in the range from 0.01 g to 1000 g, more particularly 0.05 g to 800 g, preferably 0.1 g to 500 g, more preferably 0.3 g to 300 g, very preferably 0.5 g to 100 g, especially preferably 0.5 g to 50 g.

According to one inventively preferred embodiment, the coated seed is configured such that in each case one seed grain or one individual seed is furnished, preferably completely, with the coating of the invention, so that according to this inventive embodiment, to a certain extent, single-grain systems are present. Equally, however, in the context of the present invention it is also possible for a plurality of seed grains or seeds, more particularly two, three, or four or more, to be enveloped in unison, in the manner of an agglomerate, with a coating based on the coating composition of the invention, and so in this respect, so to speak, multi-grain systems may be present.

In principle in this context the term “seed” as used in accordance with the invention should be interpreted broadly and in its general form encompasses seed of all kinds, such as, for example, seed grains, seeds, fruits, tubers, cuttings, and the like. With preference in accordance with the invention, however, the term “seed” refers to seed grains and seeds as such.

The seed here may be selected from the group of vegetable seed, cereal seed, and ornamental-plant seed, more particularly flower seed.

By way of example and in a nonlimiting way, seed suitable in accordance with the invention may be seed of leaf crop or grain crop plants, as for example root crop plants or cereal plants. More particularly the seed may be seed of oil plants, spice plants, durum wheat, wheat, barley, oats, rye, corn, soybeans, cruciferous plants, cotton, sunflowers, bananas, rice, oilseed rape, beets, sugar beets, fodder beets, potato plants, grass, fodder grass, tomatoes, leeks, squashes, cabbages, iceberg lettuces, pepper, cucumbers, melons, beans, peas, garlic seeds, carrots, sugar cane, tobacco, grapes, petunias, and geraniums, pansies, or the like.

Further advantages, properties, and features of the present invention will be apparent from the following description of exemplary embodiments of the invention, represented on the basis of the figures. In these figures

FIG. 1 shows a schematic cross section of seed of the invention corresponding to a first embodiment;

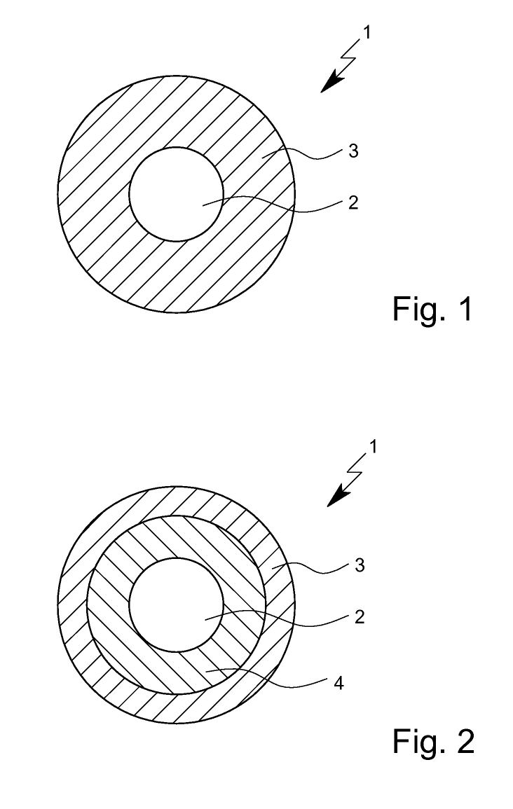

FIG. 2 shows a schematic cross section of seed of the invention according to a further inventive embodiment;

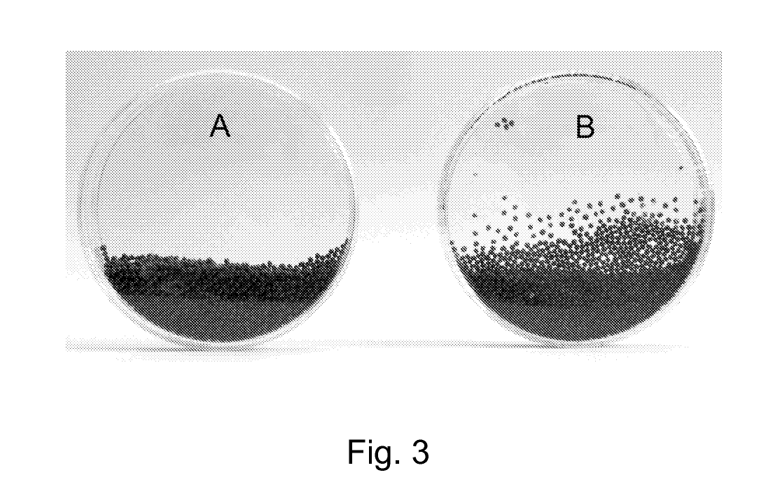

FIG. 3 shows a photograph for documenting the antistatic behavior of inventive seed (FIG. 3A) in comparison to the electrostatic behavior of noninventive seed (FIG. 3B).

FIG. 1 shows a schematic cross section through the coat construction of inventive seed 1. The core of the inventive seed is formed by a corresponding seed grain (referred to synonymously as seed grain or (plant) seed), applied on which, fully, is a coating or coat 3 based on the inventive seed coating composition, the inventive seed coating composition having at least one of the substantially metal-free, preferably metal-free, and also electrically conductive additive.

FIG. 2 shows a further inventive embodiment based on inventive seed 1, in which the core is equally formed by an individual seed grain 2. The inventive seed according to this embodiment has an inner coating or coat 4 and also, applied thereon, an outer coating or coat 3, based on the inventive coating composition.

In this context, FIG. 3A shows inventive seed based on rapeseed grains, furnished fully with a coating based on the inventive coating composition, the inventive seed having been introduced into a closed Petri dish made of polystyrene. The figure shows the antistatic behavior after repeated shaking of the Petri dish. Because of the outstanding antistatic properties, the inventive seed does not stick to the walls of the Petri dish.

FIG. 3B relates to seed which equally comprises rapeseed seeds, but these seeds have been furnished with a coating without an electrically conductive additive. After repeated shaking of the closed Petri dish, a distinct distribution or adhesion or “sticking” of the respective seed grains to the wall of the Petri dish can be observed, owing to the electrostatic effect.

Further refinements, modifications, and variations and also advantages of the present invention are readily recognizable and realizable for the skilled person on reading the description, without departing from the scope of the present invention.

The present invention is illustrated further by the working examples below, but these examples do not in any way limit the present of the invention.

### WORKING EXAMPLES

### Example 1

### Use of a Coating Composition Based on an Aqueous CNT Dispersion (Inventive)

100 g of rape seeds are brought into contact with 1 g of an aqueous CNT dispersion containing 5 wt % of multiwall carbon nanotubes (product name of the dispersion: “LP-X 21829”, BYK Chemie GmbH). The seeds are coated in a DAC 400.1-1100.1 type SpeedMixer (model DAC 400.1 FVZ) from Hausschild at 1000 revolutions per minute for 30 seconds. In the course of this coating, the surface of the seeds is wetted as completely as possible. Thereafter the coating is briefly dried at room temperature.

The rape seeds thus coated are then investigated for their antistatic behavior in a polystyrene Petri dish (e.g., article number 391-0878 from VWR International). When the sealed Petri dish is shaken a number of times, no coated seeds are left adhering to the plastic walls because of static charging. The antistatic characteristics of the coated rape seeds are therefore outstanding.

In order to determine the specific surface resistance σₛ of the coating produced, in the dried state, the dispersion on which it is based is applied to Melinex® films (material: PET) and dried. Measurement according to DIN EN 61340-2-3 (2000-12) reveals a specific surface resistance σₛ of 1.12·10² Ω/sq.

### Example 2

### Use of a Coating Composition Based on an Aqueous Carbon Black Dispersion (Inventive)

100 g of rape seeds are brought into contact with 1 g of an aqueous carbon black dispersion containing 10 wt % of carbon black (product name of the dispersion: “LP-X 21564”, BYK Chemie GmbH). The seeds are coated in a DAC 400.1-1100.1 type SpeedMixer (model DAC 400.1 FVZ) from Hausschild at 1000 revolutions per minute for 30 seconds. In the course of this coating, the surface of the seeds is wetted as completely as possible. Thereafter the coating is briefly dried at room temperature.

The rape seeds thus coated are then investigated for their antistatic behavior in a polystyrene Petri dish (e.g., article number 391-0878 from VWR International). When the sealed Petri dish is shaken a number of times, no coated seeds are left adhering to the plastic walls because of static charging. The antistatic characteristics of the coated rape seeds are therefore outstanding.

In order to determine the specific surface resistance σₛ of the coating generated, in the dried state, the dispersion used is applied to Melinex® films (material: PET) and dried. Measurement according to DIN EN 61340-2-3 (2000-12) reveals a specific surface resistance σₛ of 2.09·10³ Ω/sq.

### Example 3

### Use of a Coating Composition Based on an Electrically Conductive Organic Polymer (Inventive)

100 g of rape seeds are brought into contact with 1 g of a coating composition containing 0.8 wt % PEDOT:PSS, poly(2,3-dihydrothieno-1,4-dioxin) poly(styrenesulfonate) (product name “ORGACON IJ-1005”, Sigma-Aldrich). The seeds are coated in a DAC 400.1-1100.1 type SpeedMixer (model DAC 400.1 FVZ) from Hausschild at 1000 revolutions per minute for 30 seconds. In the course of this coating, the surface of the seeds is wetted as completely as possible. Thereafter the coating is briefly dried at room temperature.

The rape seeds thus coated are then investigated for their antistatic behavior in a polystyrene Petri dish (e.g., article number 391-0878 from VWR International). When the sealed Petri dish is shaken a number of times, no coated seeds are left adhering to the plastic walls because of static charging. The antistatic properties of the seed grains coated in accordance with this example are therefore also outstanding.

In order to determine the specific surface resistance σₛ of the coating, in the dried state, the dispersion used is applied to Melinex® films (material: PET) and dried. Measurement according to DIN EN 61340-2-3 (2000-12) reveals a specific surface resistance σₛ of 8.01·10² Ω/sq.

### Example 4

### Use of a Coating Composition Based on an Aqueous Lamp Black Dispersion (Not Inventive)

100 g of rape seeds are brought into contact with 1 g of an aqueous lamp black dispersion containing 10 wt % of nonconducting lamp black (product name: “COLOUR BLACK FW 1”, Orion Engineered Carbons). The seeds are coated in a DAC 400.1-1100.1 type SpeedMixer (model DAC 400.1 FVZ) from Hausschild at 1000 revolutions per minute for 30 seconds. In the course of this coating, the surface of the seeds is wetted as completely as possible. Thereafter the coating is briefly dried at room temperature.

The rape seeds thus coated are then investigated for their antistatic behavior in a polystyrene Petri dish (e.g., article number 391-0878 from VWR International). When the sealed Petri dish is shaken a number of times, electrostatic charging of the seeds and plastic walls is observed, with the consequence that a very large number of seeds adhere to the plastic walls of the Petri dish. Singularizing the grains, or reliably metering the grains, is therefore not possible. Overall, the antistatic properties of the coated seed grains are poor.

In order to determine the specific surface resistance σₛ of the coating generated, in the dried state, the dispersion used is applied to Melinex® films (material: PET) and dried. Measurement according to DIN EN 61340-2-3 (2000-12) reveals a specific surface resistance σₛ of 8.01·10¹² Ω/sq.

Further Investigations and Performance Studies:

In order to be able to assess the electrostatic behavior of the investigated seed further, the coated seed grains described in above-recited examples 1 to 4, in amounts that are defined in each case, are placed in a closeable polystyrene plastic cube having an edge length in each case of 10 cm. As a further, comparative example, untreated or uncoated seed in the form of rape seeds is used (example 5). The cubes loaded with each of the seeds are shaken, in order to determine the electrostatic behavior of the respective seed on this basis. Furthermore, investigations are also made of the flow behavior, by shaking the seeds out of the respective cube, and also of the meterability or singularization of each of the seed grains, by manual separation and singularization of the shaken-out seed grains, using a plastic spatula. The relevant results are shown using a school grade system (1=very good, i.e., no adhesion of the seed to the cube walls, and very good flow behavior and very good meterability and singularization; 6 =inadequate, i.e., very strongly pronounced adhesion of the seed to the cube wall, and also poor flow behavior and/or inadequate meterability and singularization). The results determined are set out in table form below.

| | Exam- | Exam- | Exam- | Exam- | Exam- |
|---|---|---|---|---|---|
| | ple 1 | ple 2 | ple 3 | ple 4 | ple 5 |
| Adhesion | 1-2 | 1 | 1-2 | 5 | 6 |
| behavior | | | | | |
| Free-flow | 1 | 1 | 1-2 | 4 | 6 |
| capacity | | | | | |
| Singularization | 1-2 | 1 | 1-2 | 4 | 6 |
| and meterability | | | | | |

The results set out above show the outstanding properties of the seed furnished with the coating composition of the invention, relative to comparable systems based on nonconductive coatings and in comparison to uncoated seed.

In a further series of investigations, moreover, the storage stability of the respective seeds of examples 1 to 5 is investigated. For this purpose, the respective samples are stored for a period of 12 weeks at a temperature of 20° C. and a relative humidity of 50%. Subsequently, germination capacity is ascertained for all the samples. While germination capacity is fully retained in the case of the coated samples based on examples 1 to 4, a reduction in germination capacity of almost 50% is observed for the uncoated seed of example 5.

The investigations above therefore provide an overall demonstration of the positive properties of seed furnished with the seed coating composition of the invention, by comparison with seed possessing nonconductive coatings and with uncoated seed.

While Applicant's invention has been described in detail above with reference to specific embodiments, it will be understood that modifications and alterations in embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

1. A seed coating composition, more particularly for the furnishing of seed, preferably seed in the form of seed grains or the like, with at least one antistatic and/or electrically conductive and/or electrodissipative coating,
where the coating composition has at least one at least substantially metal-free, preferably metal-free, electrically conductive additive.

2. The coating composition as claimed in claim 1,
where the conductive additive is salt-free, more particularly ammonium salt-free, and/or non-hygroscopic and/or free from amino groups and/or free from ether groups in form and/or
where the conductive additive is an electrically conductive carbon allotrope and/or an electrically conductive polymer.

3. The coating composition as claimed in claim 1 or 2,
where the conductive additive, more particularly the conductive carbon allotrope and/or the conductive polymer, has conjugated aromatic systems and/or conjugated double bonds and/or conjugated n electron systems and/or
where the conductive additive, more particularly the conductive carbon allotrope and/or the conductive polymer, is capable of forming preferably electrically conductive aggregates and/or electrically conductive networks and/or
where the conductive additive, more particularly the conductive carbon allotrope and/or the conductive polymer, has an electrical conductivity and/or conductance in the range from 10⁻¹³ to 10⁵ S/cm, more particularly 10⁻¹² to 10⁴ S/cm, preferably 10⁻¹⁰ to 10³ S/cm and/or
where the conductive additive, more particularly the conductive carbon allotrope and/or the conductive polymer, preferably the conductive carbon allotrope, is particle-shaped and/or particulate in form, more particularly where the conductive additive is granular, spherical, expanded, lamellar, flakelike, cylindrical, conical or frustoconical in form and/or
where the conductive additive, more particularly the conductive carbon allotrope and/or the conductive polymer, preferably the conductive carbon allotrope, has an average particle size, more particularly an average particle size D50, in the range from 0.05 nm to 1000 μm, more particularly 0.1 nm to 800 μm, preferably 1 nm to 600 μm, more preferably 10 nm to 500 μm.

4. The coating composition as claimed in claim 2 or 3,
where the conductive carbon allotrope is particle-shaped and/or particulate in form and/or
where the conductive carbon allotrope, more particularly based on the individual particles, is granular, spherical, expanded, lamellar, flakelike, cylindrical, conical or frustoconical in form and/or
where the conductive carbon allotrope has an average particle size, more particularly an average particle size D50, in the range from 0.05 nm to 1000 μm, more particularly 0.1 nm to 800 μm, preferably 1 nm to 600 μm, more preferably 10 nm to 500 μm and/or
where the conductive carbon allotrope, based on the individual particles of the carbon allotrope, has an aspect ratio, calculated as ratio of the width to the height of the particles, in the range from 1 to 10 000, more particularly greater than 1, preferably greater than 10, more preferably greater than 100.

5. The coating composition as claimed in any of claims 2 to 4,
where the carbon allotrope is selected from the group of
(i) optionally modified graphites, more particularly at least partly oxidized and/or fully or partly intercalated graphites and expandable graphites;
(ii) optionally modified graphenes, more particularly single-layer or multilayer graphenes (Few Layer Graphenes), graphene strips, and doped graphenes;
(iii) fullerenes, more particularly C₆₀ fullerene, C₇₀ fullerene, C₇₆ fullerene, C₈₀ fullerene, C₈₂ fullerene, C₈₄ fullerene, C₈₆ fullerene, C₉₀ fullerene, and C₉₄ fullerene, preferably C₆₀ fullerene and C₇₀ fullerene;
(iv) optionally modified carbon nanotubes (CNTs), more particularly doped and/or functionalized carbon nanotubes, single-wall carbon nanotubes (SWCNTs), multiwall carbon nanotubes (MWCNTs), carbon nanotubes with bamboo structure, and cup-stacked carbon nanotubes (CSCNTs);
(v) carbon blacks, more particularly Conductive Carbon Black;
(vi) carbon fibers;
(vii) optionally modified Carbon Nanohorns (CNHs), more particularly single-wall, double-wall, and multiwall Carbon Nanohorns;
(viii) Carbon Nanocones (CNCs);
(ix) Onion-Like Carbons (OLCs); and
their combinations or mixtures and/or
where graphites, graphenes, fullerenes, carbon nanotubes (CNTs) and/or carbon blacks are used as conductive carbon allotrope and/or
where carbon nanotubes (CNTs) and/or carbon blacks are used as conductive carbon allotrope.

6. The coating composition as claimed in claim 5,
where (i) the optionally modified graphites have an average particle size, more particularly an average particle size D50, based on the width of the individual graphite particles, in the range from 0.01 μm to 100 μm, more particularly 0.1 μm to 50 μm, preferably 1 μm to 30 μm and/or
where (i) the optionally modified graphites have an average particle size, more particularly an average particle size D50, based on the height of the individual graphite particles, in the range from 0.5 nm to 1000 nm, more particularly 1 nm to 500 nm, preferably 5 nm to 100 nm and/or
where (i) the optionally modified graphites have a specific surface area (BET surface area) in the range from 10 m²/g to 2000 m²/g, more particularly 15 m²/g to 1800 m²/g, preferably 20 m²/g to 1700 m²/g, more preferably 50 m²/g to 1600 m²/g.

7. The coating composition as claimed in claim 5,
where (ii) the optionally modified graphenes are used in the form of multilayer graphenes and/or where the graphenes have up to 100 layers, more particularly 1 to 100 layers, preferably 1 to 50 layers, more preferably 1 to 30 layers, very preferably 1 to 20 layers, especially preferably 1 to 10 layers.

8. The coating composition as claimed in claim 5, where (iii) the fullerenes have a particle diameter in the range from 7 Å to 15 Å.

9. The coating composition as claimed in claim 5,
where (iv) the carbon nanotubes (CNTs) used are used in the form of single-wall carbon nanotubes (SWCNTs) and/or multiwall carbon nanotubes (MWNTs), more particularly where the multiwall carbon nanotubes (MWNTs) are selected from 2- to 30-wall, preferably 3- to 15-wall, carbon nanotubes, and/or
where (iv) the carbon nanotubes (CNTs) used have average internal diameters in the range from 0.4 to 50 nm, more particularly in the range from 1 to 10 nm, preferably in the range from 2 to 6 nm, and/or
where (iv) the carbon nanotubes (CNTs) used have average external diameters in the range from 1 to 60 nm, more particularly in the range from 5 to 30 nm, preferably in the range from 10 to 20 nm, and/or
where (iv) the carbon nanotubes (CNTs) used have average lengths in the range from 0.01 to 1000 μm, more particularly in the range from 0.1 to 500 μm, preferably in the range from 0.5 to 200 μm, more preferably in the range from 1 to 100 μm, and/or where (iv) the carbon nanotubes (CNTs) used have a specific electrical conductivity of at least 10³ S/cm, more particularly at least 0.5.10⁴ S/cm, preferably at least 10⁴ S/cm.

10. The coating composition as claimed in claim 5,
where (v) the carbon blacks, more particularly the primary particles of carbon black, have an average particle size, more particularly an average particle size D50, in the range from 1 nm to 1000 nm, more particularly 10 nm to 800 nm, preferably 50 nm to 500 nm and/or
where (v) the carbon blacks have a specific surface area (BET surface area) in the range from 10 m²/g to 2000 m²/g, more particularly 15 m²/g to 1800 m²/g, preferably 20 m²/g to 1700 m²/g, more preferably 50 m²/g to 1600 m²/g and/or
where (v) the carbon blacks have an oil absorption in the range from 10 to 500 ml/100 g, more particularly 15 to 450 ml/100 g, preferably 20 to 400 ml/100 g.

11. The coating composition as claimed in claim 5,
where (vi) the carbon fibers have an average fiber diameter, more particularly an average fiber diameter D50, in the range from 1 μm to 20 μm, more particularly 2 μm to 15 μm, preferably 3 μm to 10 μm and/or
where (vi) the carbon fibers have an average fiber length, more particularly an average fiber length D50, in the range from 20 μm to 500 μm, more particularly 30 μm to 400 μm, preferably 50 μm to 300 μm and/or
where (vi) the carbon fibers have a specific electrical resistance ρ in the range from 10⁻³ Ω·m to 10⁻⁷ Ω·m, more particularly 10⁻⁴ Ω·m to 10⁻⁶ Ω·m.

12. The coating composition as claimed in claim 5,
where (vii) the Carbon Nanohorns (CNHs) have average lengths in the range from 10 to 100 nm, more particularly in the range from 20 to 80 nm, preferably in the range from 40 to 50 nm and/or
where (vii) the Carbon Nanohorns (CNHs) have average diameters in the range from 0.5 to 10 nm, more particularly in the range from 1 to 8 nm, preferably in the range from 1.5 to 5 nm, more preferably in the range from 2 to 3 nm and/or
where (vii) the Carbon Nanohorns (CNHs) have a specific surface area (BET surface area) in the range from 10 m²/g to 1500 m²/g, more particularly 15 m²/g to 1000 m²/g, preferably 20 m²/g to 800 m²/g, more preferably 50 m²/g to 500 m²/g.

13. The coating composition as claimed in claim 5, where (viii) the Carbon Nanocones (CNCs) have an at least substantially conic form and/or are conical, more particularly where the ratio of the base area diameter to the height of the Carbon Nanocones (CNCs) is in the region of 1.

14. The coating composition as claimed in claim 5, where (ix) the Onion-Like Carbons (OLCs) are at least substantially spherical and/or where (ix) the Onion-Like Carbons (OLCs) have average particle sizes, more particularly average particle sizes D50, in the range from 5 nm to 50 nm, more particularly 5 nm to 30 nm, preferably 10 nm to 20 nm.

15. The coating composition as claimed in claim 2 or 3, where the conductive polymer is selected from the group of polyacetylenes, polyanilines, polyparaphenylenes, polystyrenes, polythiophenes, polyethylenedioxythiophenes (PEDOT), polyethylene-dioxythiophenes:polystyrenesulfonates (PEDOT:PSS), and polyphenylenevinylenes, more particularly polyacetylenes, polyanilines, polyparaphenylenes, polystyrenes, and polythiophenes.

16. The coating composition as claimed in any of the preceding claims, where the coating composition has the conductive additive, more particularly the electrically conductive carbon allotrope and/or the electrically conductive polymer, in amounts in the range from 0.0001 wt % to 70 wt %, more particularly 0.001 wt % to 60 wt %, preferably 0.01 wt % to 50 wt %, more preferably 0.1 wt % to 40 wt %, very preferably 0.2 wt % to 20 wt %, especially preferably 0.5 wt % to 15 wt %, more preferably still 1 wt % to 10 wt %, based on the composition.

17. The coating composition as claimed in any of the preceding claims,
where the coating composition is present as a dispersion, preferably as an aqueous and/or aqueously based dispersion, and/or as a solubilizate, more particularly aqueous and/or aqueously based solubilizate, more particularly where the conductive additive, more particularly the electrically conductive carbon allotrope and/or the electrically conductive polymer, is incorporated in a continuous phase and/or in at least one carrier medium, more particularly dispersion medium and/or solubilization medium, and/or
where the coating composition is in the form of a dispersion, preferably an aqueous and/or aqueously based dispersion.

18. The coating composition as claimed in claim 17,
where use is made as continuous phase and/or carrier medium, more particularly as dispersion medium and/or solubilization medium, of an aqueously, organically or aqueous-organically based carrier medium, more particularly dispersion medium and/or solubilization medium, preferably an aqueously or aqueously organic carrier medium, more preferably aqueously based carrier medium, and/or
where use is made as continuous phase and/or carrier medium of a carrier medium which is present in the liquid aggregate state under dispersing and/or solubilizing conditions, more particularly under atmospheric pressure (101.325 kPa) and in a temperature range from 10 to 100° C., preferably 15 to 70° C.

19. The coating composition as claimed in claim 17 or 18,
where the carrier medium, more particularly the dispersion medium and/or the solubilization medium, is selected from the group of (i) water;
(ii) alcohols, more particularly straight-chain, branched or cyclic, monohydric or polyhydric alcohols; (iii) ether alcohols; (iv) hydrocarbons; (v) ethers; (vi) carboxylic esters; (vii) ether esters; (viii) lactones; (ix) plasticizers, more particularly phthalates; (x) aldehydes and ketones; (xi) acid amides, (xii) N-methylpyrrolidone; and also combinations of the aforesaid carrier media and/or
where the carrier medium, more particularly the dispersion medium and/or the solubilization medium, comprises water and/or where the dispersion medium is water.

20. The coating composition as claimed in any of claims 17 to 19, where the coating composition comprises the carrier medium, more particularly the dispersion medium and/or the solubilization medium, in amounts in the range from 0.1 wt % to 99 wt %, more particularly 1 wt % to 95 wt %, preferably 5 wt % to 90 wt %, more preferably 10 wt % to 80 wt %, very preferably 20 wt % to 60 wt %, based on the composition, and/or
where the coating composition comprises the carrier medium, more particularly the dispersion medium and/or the solubilization medium, in amounts in the range from 10 wt % to 1000 wt %, more particularly 25 wt % to 500 wt %, preferably 50 wt % to 400 wt %, more preferably 75 wt % to 350 wt %, very preferably 100 wt % to 300 wt %, especially preferably 150 wt % to 250 wt %, based on the conductive additive, more particularly the electrically conductive carbon allotrope and/or the electrically conductive polymer.

21. The coating composition as claimed in any of the preceding claims, where the coating composition comprises at least one dispersant and/or wetting agent, more particularly a polymeric dispersant and/or wetting agent, preferably based on a functionalized polymer, preferably having a number-average molecular mass of at least 500 g/mol, preferably at least 1000 g/mol, more preferably at least 2000 g/mol, more particularly where the dispersant is selected from the group of polymers and copolymers having functional and/or pigment-affinity groups, alkylammonium salts of polymers and copolymers, polymers and copolymers having acidic groups, comb copolymers and block copolymers, such as block copolymers having, in particular, basic pigment-affinity groups, optionally modified acrylate block copolymers, optionally modified polyurethanes, optionally modified and/or salinated polyamines, phosphoric esters, ethoxylates, polymers and copolymers with fatty acid radicals, optionally modified polyacrylates, such as transesterified polyacrylates, optionally modified polyesters, such as acid-functional polyesters, polyphosphates, and combinations thereof.

22. The coating composition as claimed in claim 21, where the coating composition comprises the dispersant and/or wetting agent in amounts in the range from 0.1 wt % to 50 wt %, more particularly 0.5 wt % to 40 wt %, preferably 1 wt % to 30 wt %, more preferably 2 wt % to 10 wt %, based on the composition. 15

23. The coating composition as claimed in any of the preceding claims, where the coating composition has at least one matrix and/or scaffold substance, more particularly where the matrix and/or scaffold substance is selected from the group of natural, nature-identical, and synthetic polymers, preferably water-soluble and/or water-dispersible polymers, and/or more particularly where the matrix and/or scaffold substance is selected from the group of methylcellulose, carboxymethyl-cellulose, hydroxypropylcellulose, alginate, gelatin, casein, polyurethanes, polyacrylates, polyacrylamides, polyvinyl alcohols, polyvinyl acetates, polyvinylpyrrolidones, and waxes, more particularly beeswax, carnauba wax, polyethylene wax, and polypropylene wax, and combinations thereof.

24. The coating composition as claimed in claim 23, where the coating composition comprises the matrix and/or scaffold substance in amounts in the range from 0.5 wt % to 70 wt %, more particularly 1 wt % to 60 wt %, preferably 2 wt % to 50 wt %, more preferably 5 wt % to 20 wt %, based on the composition.

25. The coating composition as claimed in any of the preceding claims, where the coating composition has at least one thickener and/or one viscosity-increasing agent, more particularly where the thickener and/or the viscosity-increasing agent is selected from the group of pectins, alginates, tragacanth, gum arabic, guar gum, carrageenan, carboxymethylcellulose, carboxypropylcellulose, polyacrylates, polysaccharides, urea derivatives, and clays, more particularly bentonite clays, and combinations thereof.

26. The coating composition as claimed in claim 25, where the coating composition comprises the thickener and/or the viscosity-increasing agent in amounts in the range from 0.001 wt % to 25 wt %, more particularly 0.01 wt % to 10 wt %, preferably 0.05 wt % to 5 wt %, more particularly 0.1 wt % to 4 wt %, very preferably 0.5 wt % to 2 wt %, based on the composition.

27. The coating composition as claimed in any of the preceding claims, where the coating composition has at least one defoamer, more particularly where the defoamer is selected from the group of polyethers, polyacrylates, glycerol, polyethylene glycol, and polysiloxanes, and combinations thereof.

28. The coating composition as claimed in claim 27, where the coating composition comprises the defoamer in amounts in the range from 0.001 wt % to 3 wt %, more particularly 0.01 wt % to 2 wt %, preferably 0.1 wt % to 1 wt %, more preferably 0.2 wt % to 1 wt %, based on the composition.

29. The coating composition as claimed in any of the preceding claims, where the coating composition comprises at least one granulating assistant, more particularly where the granulating assistant is a wax, more particularly beeswax, carnauba wax, polyethylene wax and/or polypropylene wax.

30. The coating composition as claimed in any of the preceding claims, where the coating composition comprises at least one pelletizing agent, more particularly where the pelletizing agent is peat, clay and/or starch.

31. The coating composition as claimed in any of the preceding claims, where the coating composition comprises at least one further additive and/or at least one further ingredient, more particularly where the further additive and/or the further ingredient are/is selected from the group of fillers, more particularly carbonates, preferably calcium carbonate; granulating agents; adhesion promoters; rheology modifiers; pH modifiers; antiblocking and/or antistick agents, more particularly waxes; plasticizers; UV adsorbers; flow control agents; dyes and color pigments; and combinations thereof.

32. The coating composition as claimed in claim 31, where the coating composition comprises the further additive and/or the further ingredient in amounts in the range from 0.0001 wt % to 40 wt %, more particularly 0.001 wt % to 30 wt %, preferably 0.01 wt % to 20 wt %, more preferably 0.1 wt % to 15 wt %, based on the composition.

33. The coating composition as claimed in any of the preceding claims, where the coating composition comprises at least one biologically active ingredient, more particularly where the biologically active ingredient is selected from the group of biocides, more particularly fungicides, herbicides, bactericides, insecticides, microbicides, molluscicides, and virucides; fertilizers; nutrients; vitamins; germination and/or growth regulators, more particularly hormones, preferably phytohormones; and combinations thereof.

34. The coating composition as claimed in claim 33, where the coating composition comprises the biologically active ingredient in amounts in the range from 0.0001 wt % to 20 wt %, more particularly 0.001 wt % to 15 wt %, preferably 0.01 wt % to 10 wt %, more preferably 0.1 wt % to 5 wt %, based on the composition.

35. The coating composition as claimed in any of the preceding claims, where the coating composition is at least substantially metal-free, more particularly metal-free, preferably heavy metal-free, or at least low-metal-content, more particularly low-heavy-metal-content, in form, more particularly where the coating composition has a metal content, more particularly a heavy metal content, of at most 0.1 wt %, more particularly at most 0.01 wt %, preferably at most 0.001 wt %, more preferably at most 0.0001 wt %, very preferably at most 0.00001 wt %, especially preferably at most 0.000001 wt %, based on the composition.

36. The coating composition as claimed in any of the preceding claims, where the coating composition is at least substantially free from metal-containing pigments and/or metal-containing dyes.

37. The coating composition as claimed in any of the preceding claims, where the coating composition has a fluid and/or liquid consistency in particular under processing and/or use conditions, more particularly under atmospheric pressure (101.325 kPa) and in a temperature range from 10 to 100° C., preferably 15 to 70° C.

38. The coating composition as claimed in any of the preceding claims,
where the coating composition, in particular under processing and/or use conditions, more particularly under atmospheric pressure (101.325 kPa) and in a temperature range from 10 to 100° C., preferably 15 to 70° C., has a dynamic viscosity in the range from 10 to 50 000 mPa·s, more particularly 25 to 30 000 mPa·s, preferably 50 to 25 000 mPa·s, more preferably 75 to 20 000 mPa·s and/or
where the coating composition in the dried and/or cured state has a total residual moisture content of 0.001 to 5 wt %, more particularly 0.01 to 3 wt %, preferably 0.1 to 2 wt %, more preferably 0.5 to 1 wt %, based on the coating composition and/or
where the coating composition in the dried and/or cured state has a total residual moisture content of at most 5 wt %, more particularly at most 3 wt %, preferably at most 2 wt %, more preferably at most 1 wt %, based on the coating composition.

39. The coating composition as claimed in any of the preceding claims,
where the coating composition in the dried and/or cured state has a specific surface resistance σₛ of at most 10¹² Ω/sq, more particularly at most 10¹¹ Ω/sq, preferably at most 10¹⁰ Ω/sq, more preferably at most 10⁹ Ω/sq, very preferably at most 10⁸ Ω/sq and/or
where the coating composition in the dried and/or cured state has a specific surface resistance σₛ in the range from 10⁻³ Ω/sq to 10¹² Ω/sq, more particularly in the range from 10⁻¹ Ω/sq to 10¹¹ Ω/sq, preferably in the range from 10⁰ Ω/sq to 10¹⁰ Ω/sq, more preferably in the range from 10¹ Ω/sq to 10⁹ Ω/sq, very preferably in the range from 10² Ω/sq to 10⁸ Ω/sq.

40. The coating composition as claimed in any of the preceding claims,
where the coating composition in the dried and/or cured state has a specific resistance ρₛ and/or a resistivity of at most 10¹⁰ Ω·m, more particularly at most 10⁵ Ω·m, preferably at most 10³ Ω·m and/or where the coating composition in the dried and/or cured state has a specific resistance ρₛ and/or a resistivity in the range from 10⁻⁷ Ω·m to 10¹⁰ Ω·m, more particularly in the range from 10⁻⁶ Ω·m to 10⁵ Ω·m, preferably in the range from 10⁻⁵ Ω·m to 10³ Ω·m.

41. The use of at least one at least substantially metal-free, preferably metal-free, electrically conductive additive, more particularly of an electrically conductive carbon allotrope and/or of an electrically conductive polymer, preferably as defined in any of claims 1 to 16, for producing an antistatic and/or electrically conductive and/or electrodissipative seed coating composition and/or seed coating.

42. The use of at least one at least substantially metal-free, preferably metal-free, electrically conductive additive, more particularly of an electrically conductive carbon allotrope and/or of an electrically conductive polymer, preferably as defined in any of claims 1 to 16, for the antistatic and/or electrically conductive and/or electrodissipative furnishing of seed, more particularly seed coating.

43. The use of a coating composition for the antistatic and/or electrically conductive and/or electrodissipative furnishing of seed, where the coating composition has at least one at least substantially metal-free, preferably metal-free, electrically conductive additive, more particularly an electrically conductive carbon allotrope and/or an electrically conductive polymer, preferably as defined in any of claims 1 to 16.

44. A method for producing an antistatic and/or electrically conductive and/or electrodissipative seed coating composition, more particularly for the furnishing of seed, where at least one at least substantially metal-free, preferably metal-free, electrically conductive additive, more particularly an electrically conductive carbon allotrope and/or an electrically conductive polymer, preferably as defined in any of claims 1 to 16, is dispersed in a continuous phase and/or in a carrier medium, more particularly dispersion medium and/or solubilization medium, preferably in the presence of at least one dispersant and/or wetting agent, with introduction of an energy input sufficient for dispersing.

45. A seed coating composition, more particularly for the antistatic and/or electrically conductive and/or electrodissipative furnishing of seed, where the seed coating composition is obtainable by the method as claimed in claim 44.

46. A method for producing seed furnished with a coating, preferably seed in the form of seed grains or the like, having antistatic and/or electrically conductive and/or electrodissipative properties, where the seed is furnished and/or more particularly coated with a seed coating composition as defined in any of claims 1 to 40 and/or in claim 45.

47. The method as claimed in claim 46, where the coating is obtained by bringing the seed coating composition, more particularly by applying and/or spraying the seed coating composition, onto the seed, more particularly followed by drying and/or curing of the seed coating composition.

48. Seed, more particularly seed in the form of seed grains or the like, where the seed is furnished with at least one antistatic and/or electrically conductive and/or electrodissipative coating, where the coating has or consists of a seed coating composition, more particularly as defined in any of claims 1 to 40 and/or in claim 45.

49. The seed as claimed in claim 48, where the coating is disposed as outermost coat on the seed and/or where the coating at least substantially fully surrounds and/or envelops the seed, and/or where the coating is at least substantially continuous in form.

50. The seed as claimed in claim 48 or 49, where the coating has a coat thickness in the range from 1 nm to 5 mm, more particularly in the range from 2 nm to 4 mm, preferably in the range from 5 nm to 3 mm, more preferably in the range from 10 nm to 2 mm, very preferably in the range from 100 nm to 1 mm, especially preferably in the range from 1000 nm to 0.5 mm.

51. The seed as claimed in any of claims 48 to 50,
where the coating has a specific surface resistance σₛ of at most 10¹² Ω/sq, more particularly at most 10¹¹ Ω/sq, preferably at most 10¹⁰ Ω/sq, more preferably at most 10⁹ Ω/sq, very preferably at most 10⁸ Ω/sq and/or
where the coating has a specific surface resistance σₛ in the range from 10⁻³ Ω/sq to 10¹² Ω/sq, more particularly in the range from 10⁻¹ Ω/sq to 10¹¹ Ω/sq, preferably in the range from 10⁰ Ω/sq to 10¹⁰ Ω/sq, more preferably in the range from 10¹ Ω/sq to 10⁹ Ω/sq, very preferably in the range from 10² Ω/sq to 10⁸ Ω/sq.

52. The seed as claimed in any of claims 48 to 51,
where the coating has a specific resistance ρₛ and/or a resistivity of at most 10¹⁰ Ω·m, more particularly at most 10⁵ Ω·m, preferably at most 10³ Ω·m and/or
where the coating in the dried and/or cured state has a specific resistance ρₛ and/or a resistivity in the range from 10⁻⁷ Ω·m to 10¹⁰ Ω·m, more particularly in the range from 10⁻⁶ Ω·m to 10⁵ Ω·m, preferably in the range from 10⁻⁵ Ω·m to 10³ Ω·m.

53. The seed as claimed in any of claims 48 to 52,
where the seed has a particle size and/or grain size, more particularly an average particle size and/or grain size D50, in the range from 0.01 mm to 5 cm, more particularly in the range from 0.05 mm to 2 cm, preferably in the range from 0.1 mm to 1 cm, more preferably in the range from 0.2 mm to 5 mm, very preferably in the range from 0.3 mm to 3 mm, especially preferably 0.5 mm to 2 mm and/or
where the seed has a thousand kernel mass (TKM) in the range from 0.01 g to 1000 g, more particularly 0. 05 g to 800 g, preferably 0.1 g to 500 g, more preferably 0.3 g to 300 g, very preferably 0.5 g to 100 g, especially preferably 0.5 g to 50 g.

54. The seed as claimed in any of claims 48 to 53, where the seed is selected from the group of vegetable seed, cereal seed, and ornamental-plant seed, more particularly flower seed.
